(19) United States
(12) Patent Application Publication
(10) Pub. No.: US 2023/0342363 A1
(43) Pub. Date: Oct. 26, 2023

(54) INFORMATION PROCESSING METHOD, INFORMATION PROCESSING DEVICE, AND RECORDING MEDIUM

(71) Applicant: ESS Holdings Co., Ltd., Chiba (JP)

(72) Inventor: Shinji FURUSHO, Kanagawa (JP)

(21) Appl. No.: 18/343,061

(22) Filed: Jun. 28, 2023

Related U.S. Application Data
(63) Continuation of application No. PCT/JP2021/000851, filed on Jan. 13, 2021.

(51) Int. Cl. G06F 16/2455

(52) U.S. Cl. CPC G06F 16/2456

(57) ABSTRACT

With respect to an information processing method to be performed by a computer, the information processing method includes performing aggregation in a plurality of dimensions included in a virtual table for each value of a predetermined key, two tables in a natural number index format being combined by join using the predetermined key in the virtual table, and calculating a sum of results of the aggregation.

### CROSS-REFERENCE TO RELATED APPLICATIONS

This application is a continuation application of International Application No. PCT/JP2021/000851 filed on Jan. 13, 2021, and designating the U.S., the entire contents of which are incorporated herein by reference.

### BACKGROUND

### 1. Technical Field

The present disclosure relates to an information processing method, an information processing device, and a non-transitory computer-readable recording medium storing a program.

### 2. Description of the Related Art

Various databases represented by a relational database (RDB) are known. A database, such as the RDB, targets tabular data, and supports various operations such as joining, searching, sorting, and aggregating. A technique described in Patent Document 1 is known as a related technique for performing join on multiple tabular data at high speed without using a large amount of memory.

In the technique described in Patent Document 1, an array or a value list is used to realize speeding up a join operation for multiple tabular data, and various operations for tabular data obtained after join is performed can also be speeded up.

### RELATED ART DOCUMENT

### Patent Document

[Patent Document 1] Japanese Laid-Open Patent Application Publication No. 2003-150633

### SUMMARY

According to one embodiment of the present disclosure, with respect to an information processing method to be performed by a computer, the information processing method includes performing aggregation in a plurality of dimensions included in a virtual table for each value of a predetermined key, two tables in a natural number index format being combined by join using the predetermined key in the virtual table, and calculating a sum of results of the aggregation.

### BRIEF DESCRIPTION OF THE DRAWINGS

FIG. 1 is a diagram illustrating an example of a hardware configuration of a data processing device according to the present embodiment;

FIG. 2 is a diagram illustrating an example of a functional configuration of the data processing device according to the present embodiment;

FIG. 3 is a diagram illustrating examples of a table;

FIG. 4 is a diagram illustrating examples of a table in an NNI format;

FIG. 5 is a diagram depicting an example of preparation of a conversion array and a newSVL;

FIG. 6 is a diagram depicting an example of creation of the newSVL;

FIG. 7 is a diagram depicting an example of conversion of an NNC;

FIG. 8 is a diagram illustrating an example of a result of creating a common SVL;

FIG. 9 is a diagram illustrating examples of inner join and outer join;

FIG. 10 is a diagram depicting an example of a change in a method of representing an NNI format table;

FIG. 11 is a diagram illustrating an example of tables on which join is to be performed and its NNI format;

FIG. 12 is a diagram depicting an example of a table after a common SVL creating process;

FIG. 13 is a diagram depicting an example of an SAcm creating process in inner join;

FIG. 14 is a diagram depicting an example of a MAcm creating process in inner join;

FIG. 15 is a diagram illustrating an example of an inner join table in the NNI format;

FIG. 16 is a diagram illustrating an example of an inner join table;

FIG. 17 is a first diagram depicting an example of an SAcm creating process in outer join;

FIG. 18 is a second diagram depicting the example of the SAcm creating process in outer join;

FIG. 19 is a third diagram depicting the example of the SAcm creating process in outer join;

FIG. 20 is a first diagram depicting an example of a MAcm creating process in outer join;

FIG. 21 is a second diagram depicting the example of the MAcm creating process in outer join;

FIG. 22 is a diagram illustrating an example of an outer join table in the NNI format;

FIG. 23 is a diagram illustrating an example of an outer join table;

FIG. 24 is a diagram depicting an example of reading of a right outer join portion;

FIG. 25 is a diagram depicting an example of reading of a left outer join portion;

FIG. 26 is a diagram depicting an example of reading of an inner join portion;

FIG. 27 is a diagram illustrating an example of a table on which join using multiple columns as keys is to be performed and its NNI format;

FIG. 28 is a diagram illustrating an example of a table on which join using multiple columns as keys is to be performed after the common SVL creating process, and its NNI format;

FIG. 29 is a diagram illustrating an example of a multi-key field;

FIG. 30 is a diagram depicting an example of sorting and transposition of an EOrdSet;

FIG. 31 is a first diagram depicting an example of creation of an SVL and a Conv sequence;

FIG. 32 is a second diagram depicting the example of the creation of the SVL and the Conv sequence;

FIG. 33 is a diagram illustrating an example of an NNI format table for join using multiple columns as keys;

FIG. 34 is a diagram depicting an example of a common SVL creating process in join using multiple columns as keys;

FIG. 35 is a diagram illustrating an example of a table to be aggregated;

FIG. 36 is a diagram depicting an example of decomposition by a join key value;

FIG. 37 is a diagram depicting an example of a product of tables;

FIG. 38 is a diagram illustrating an example of an aggregation result table;

FIG. 39 is a diagram depicting an example of a sum and a product in a sort method;

FIG. 40 is a diagram depicting an example of a sum and a product in a cube method;

FIG. 41 is a diagram depicting an example of a column transfer;

FIG. 42 is a diagram illustrating an example of an extraction target table of a matched set in join and an unmatched set in join;

FIG. 43 is a diagram illustrating an example of an NNI format of an extraction target table of the matched set in join and the unmatched set in join;

FIG. 44 is a first diagram depicting an example of extraction of the matched set in join and the unmatched set in join; and

FIG. 45 is a second diagram depicting the example of the extraction of the matched set in join and the unmatched set in join.

### DETAILED DESCRIPTION

An operation for tabular data obtained after join is performed can be speeded up.

In the following, an embodiment of the present invention will be described. In the present embodiment, a data processing device 10 that can perform, at high speed, various operations on tabular data obtained after join is performed on multiple tabular data will be described. Here, in the present embodiment, as examples of the various operations, five operations of sorting, searching, and aggregating the tabular data after join, extracting a matched set in join and an unmatched set in join, and column transfer will be described. Hereinafter, the tabular data is also referred to as “table data” or simply “table”, and each piece of data constituting the table (i.e., each row of the table) is also referred to as a “record”. Additionally, a column (data item) of the table is also referred to as a “column”.

<Natural Number Index>

First, a method called natural number index (NNI) will be described. The natural number index is a method devised by the inventor, and divides a table into data columns, and divides each data column into the following two types of arrays:
a sorted value list (SVL); and
a natural numbered column (NNC).
   Hereinafter, this division is also referred to as “component decomposition”.

The SVL is an array in which values appearing in a column are arranged in ascending order without duplication. The NNC is an array represented by each value of the column being replaced with a storage position of the value in the SVL. Therefore, a value of each element of the NNC does not exceed the array size of the SVL at most. Additionally, in the natural number index, the storage position of each element of the NNC is referred to as a record number.

Here, the SVL described above is called a “value list” and the NNC is called a “pointer array” in Patent Document 1. That is, the natural number index is a name of a method of dividing a table into a value list and a pointer array for each column in Patent Document 1.

The natural number index uses an OrdSet (an ordered set), which is an array for handling an “ordered set” in mathematics. The OrdSet is created by arranging record numbers (positions in the NNC). Because the OrdSet is a set, no duplicate elements appear. Additionally, a value of each element does not exceed the size of the NNC. Here, the OrdSet described above is called an “ordered set” in Patent Document 1.

By using the OrdSet, a record group hit by a search can be recorded, and the order of a record group rearranged by sorting can be recorded. Additionally, every time searching or sorting is performed, a new OrdSet is created. Therefore, by switching the OrdSets, a table before performing processing such as searching and sorting and a table after performing processing such as searching and sorting can be read.

In the present embodiment, multiple tables are represented by the natural number index, the SVLs thereof are changed to a common SVL, and join is performed using the common SVL to create a join table represented by the natural number index. Then, various operations such as sorting, searching, aggregating, extracting of a matched set in join and an unmatched set in join, and column transfer are performed on the join table. This enables various operations to be performed on the join table at high speed. Hereinafter, a table represented by the natural number index is also referred to as a “natural number index format table” or a “NNI format table”.

Here, although many arrays are used in the natural number index, in the present embodiment, the array is defined as follows.
The array is 0-based and its elements are referenced by integers greater than or equal to 0. Thus, for example, the elements of an array A having a size N are A[0], A[1], . . . , A[N−1].
A[−1]=0, when A is an array.

<Hardware Configuration>

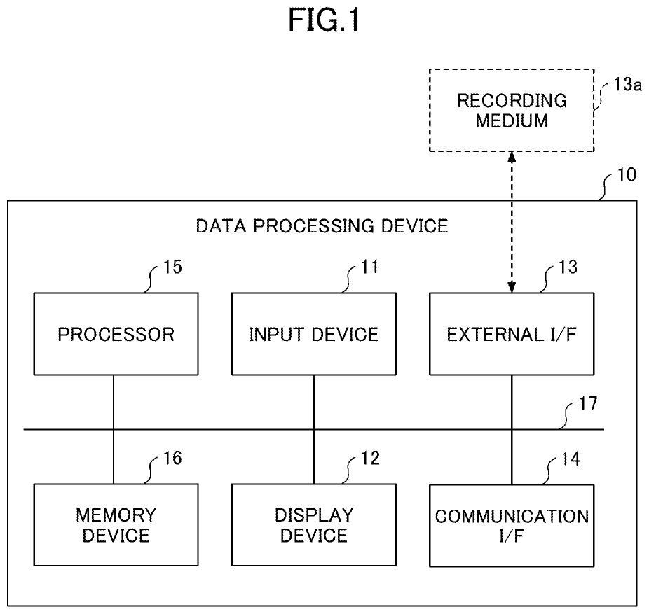

Next, a hardware configuration of the data processing device 10 according to the present embodiment will be described with reference to FIG. 1. FIG. 1 is a diagram illustrating an example of the hardware configuration of the data processing device 10 according to the present embodiment.

As illustrated in FIG. 1, the data processing device 10 according to the present embodiment is implemented by a hardware configuration of a general computer or computer system, and includes an input device 11, a display device 12, an external I/F 13, a communication I/F 14, a processor 15, and a memory device 16. These hardware components are connected via a bus 17 to communicate with each other.

The input device 11 is, for example, a keyboard and mouse, a touch panel, or the like. The display device 12 is, for example, a display or the like. Here, the data processing device 10 may not include at least one of the input device 11 and the display device 12, for example.

The external I/F 13 is an interface with an external device such as a recording medium 13a. The data processing device 10 can read and write information from and to the recording medium 13a via the external I/F 13. Examples of the recording medium 13a include a compact disc (CD), a digital versatile disk (DVD), a secure digital memory card (SD memory card), and a universal serial bus (USB) memory card.

The communication I/F 14 is an interface for connecting the data processing device 10 to a communication network. The processor 15 is, for example, one or a combination of various arithmetic devices such as a central processing unit (CPU) and a graphics processing unit (GPU). The memory device 16 is, for example, one or a combination of various storage devices such as a hard disk drive (HDD), a solid state drive (SSD), a random access memory (RAM), a read only memory (ROM), and a flash memory.

The data processing device 10 according to the present embodiment has the hardware configuration illustrated in FIG. 1, and thus can realize various processes to be described later. Here, the hardware configuration illustrated in FIG. 1 is an example, and the data processing device 10 may have another hardware configuration. For example, the data processing device 10 may include multiple processors 15 or multiple memory devices 16.

<Functional Configuration>

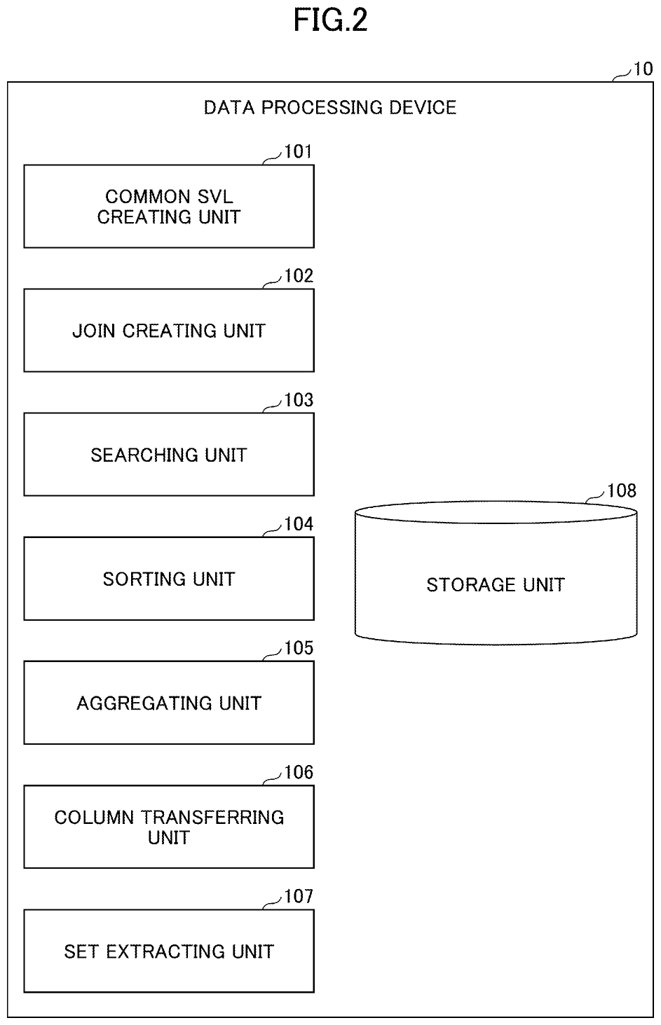

Next, a functional configuration of the data processing device 10 according to the present embodiment will be described with reference to FIG. 2. FIG. 2 is a diagram illustrating an example of the functional configuration of the data processing device 10 according to the present embodiment.

As illustrated in FIG. 2, the data processing device 10 according to the present embodiment includes a common SVL creating unit 101, a join creating unit 102, a searching unit 103, a sorting unit 104, an aggregating unit 105, a column transferring unit 106, and a set extracting unit 107. These units are achieved by, for example, processes that one or more programs installed in the data processing device 10 cause the processor 15 to execute.

Additionally, the data processing device 10 according to the present embodiment includes a storage unit 108. The storage unit 108 is implemented by, for example, the memory device 16. However, the storage unit 108 may be implemented by, for example, a storage device (a database server or the like) connected to the data processing device 10 via a communication network.

The storage unit 108 stores various tables on which join and various operations are performed. Here, the tables stored in the storage unit 108 are assumed to be NNI format tables.

The common SVL creating unit 101 creates a common SVL of the NNI format tables. The join creating unit 102 performs join on multiple NNI format tables to create a join table in the NNI format. The searching unit 103 searches the join table in the NNI format. The sorting unit 104 sorts the join table in the NNI format. The aggregating unit 105 aggregates the join table in the NNI format. The column transferring unit 106 performs column transfer for transferring a column of one table serving as a join source to the other table with respect to the join table in the NNI format. The set extracting unit 107 extracts a matched set in join and an unmatched set in join from the join table in the NNI format.

### Example

In the following, examples of joining two tables, searching the join table, sorting the join table, aggregating the join table, performing the column transfer on the join table, and extracting a matched set in join and an unmatched set in join from the join table will be described below. Before describing join, common SVL creation required when join is performed on two tables in the NNI format will be described.

[Common SVL Creation]

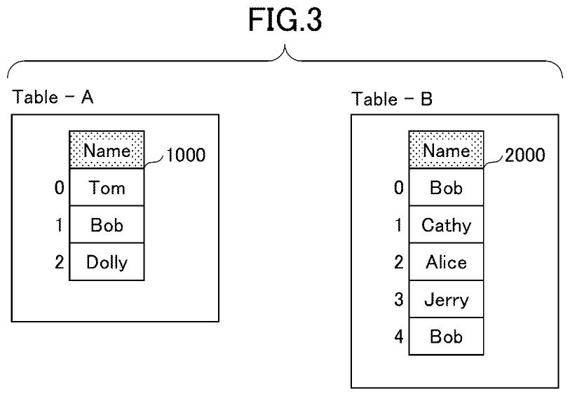

In the present embodiment, as an example, common SVL creation for a table 1000 (Table-A) and a table 2000 (Table-B) illustrated in FIG. 3 will be described.

The table 1000 includes records including a column “Name”, and a Name value of each record is as follows.
A Name value of a record with a record number “0” is “Tom”.
A Name value of a record with a record number “1” is “Bob”.
A Name value of a record with a record number “2” is “Dolly”.
   Additionally, the table 2000 includes records including the column “Name”, and a Name value of each record is as follows.
A Name value of a record with the record number “0” is “Bob”.
A Name value of a record with the record number “1” is “Cathy”.
A Name value of a record with the record number “2” is “Alice”.
A Name value of a record with the record number “3” is “Jerry”.
A Name value of a record with the record number “4” is “Bob”.
   Here, in the example illustrated in FIG. 3, each record of the table 1000 and the table 2000 includes only one column, but this is for simplifying the description of the present embodiment, and naturally, multiple columns may be included. When each record includes multiple columns, the NNC and the SVL of the natural number index are created for each column in each table, as described above.

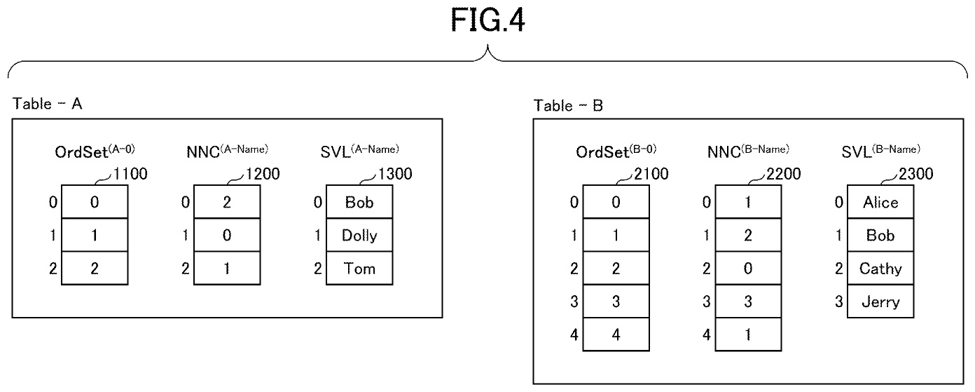

FIG. 4 illustrates tables obtained by expressing the table 1000 and the table 2000 illustrated in FIG. 3 by the natural number index.

As described above, an OrdSet is created for each table, and a new OrdSet is created every time searching, sorting, or the like is performed. Therefore, in order to clearly indicate which table and which OrdSet, “(table name-identification number)” may be expressed on the right shoulder position. For example, the 0th OrdSet of Table-A may be expressed as OrdSet^{(A-0)}. However, when the table name is obvious, “(identification number)” is added on the left shoulder position and the table name is omitted.

Additionally, the SVL and NNC may be expressed by adding “(table name-column name)” on the right shoulder position in order to clearly indicate which table and which column the SVL and NNC correspond to. For example, an SVL corresponding to the column “Name” of Table-A may be expressed as SVL^{(A-Name)}.

FIG. 4 illustrates an example in which the table 1000 (Table-A) is decomposed into components: an OrdSet 1100 (OrdSet^{(A-0)}), an NNC 1200 (NNC^{(A-Name)}), and an SVL 1300 (SVL^{(A-Name)}). Similarly, FIG. 4 illustrates an example in which the table 2000 (Table-B) is decomposed into components: an OrdSet 2100 (OrdSet^{(a-0)}), an NNC 2200 (NNC^{(B-Name)}), and an SVL 2300 (SVL^{(B-Name)}).

Here, the SVL 1300 is an array in which the values appearing in the column “Name” of the table 1000 are arranged in ascending order without duplication. The NNC 1200 is an array expressed by replacing each value in the column “Name” of the table 1000 with the storage position of a corresponding value in the SVL 1300. For example, because the Name value “Tom” of the record number “0” of the table 1000 is stored at the storage position “2” in the SVL 1300, the element of the storage position “0” in the NNC 1200 is “2”. Similarly, because the Name value “Bob” of the record number “1” of the table 1000 is stored at the storage position “0” in the SVL 1300, the element of the storage position “1” in the NNC 1200 is “0”. Similarly, because the Name value “Dolly” of the record number “2” of the table 1000 is stored at the storage position “1” in the SVL 1300, the element of the storage position “2” in the NNC 1200 is “1”.

Additionally, the OrdSet 1100 is created by arranging the record numbers (that is, positions in the NNC) of the table 1000 without change. For the OrdSet 2100, the NNC 2200 and the SVL 2300, the values of the elements of the arrays are determined in substantially the same manner.

In the following, a case in which a common SVL is created by using the NNC 1200 and the SVL 1300, and the NNC 2200 and the SVL 2300 illustrated in FIG. 4 will be described. Here, the OrdSet 1100 and the OrdSet 2100 are not particularly used for creating a common SVL.

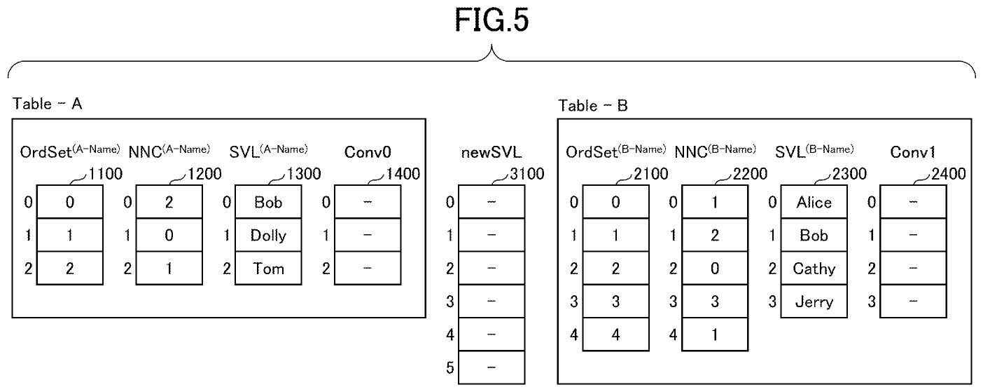

First, the common SVL creating unit 101 prepares conversion arrays each having the same size as the SVL and a common SVL (newSVL) for storing each value of each SVL. That is, as illustrated in FIG. 5, the common SVL creating unit 101 prepares a conversion array 1400 (Conv0) having the same size as the SVL 1300, a conversion array 2400 (Conv1) having the same size as the SVL 2300, and a newSVL 3100 for storing the values of the SVL 1300 and the SVL 2300. Here, the size of the newSVL 3100 is the total number of values obtained by excluding duplication in the SVL 1300 and the SVL 2300 (that is, the size of the SVL 1300+the size of the SVL 2300−the number of duplicated values in the SVL 1300 and the SVL 2300).

Next, the common SVL creating unit 101 compares the values of the respective SVLs from the head, stores a smaller value in the newSVL, and stores a storage position of the smaller value in the conversion array corresponding to the SVL in which the smaller value is stored. Additionally, after the storage position is stored in the conversion array, the common SVL creating unit 101 lowers, by one, the comparison position of the SVL corresponding to the conversion array. Here, when the values at the comparison positions in the respective SVLs are identical, the common SVL creating unit 101 stores the storage position of the value in the newSVL in both conversion arrays, and lowers, by one, the comparison positions of both SVLs.

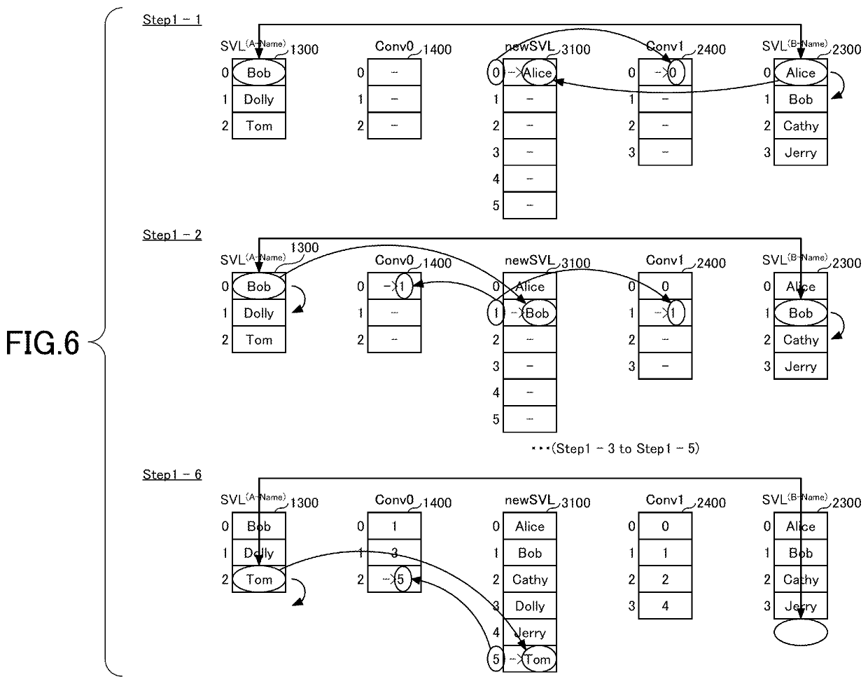

Specifically, as illustrated in FIG. 6, the common SVL creating unit 101 performs Step 1-1 to Step 1-6. Here, the initial state of the comparison position of the SVL 1300 and the initial state of the comparison position of the SVL 2300 are both the top (i.e., a position “0”).

Step 1-1: First, the common SVL creating unit 101 compares the value “Bob” stored at the position “0” of the SVL 1300 with the value “Alice” stored at the position “0” of the SVL 2300. In this case, because “Alice” is a smaller value, the common SVL creating unit 101 stores “Alice” in the newSVL 3100 and stores the storage position “0” in the conversion array 2400 (Conv1). Then, the common SVL creating unit 101 lowers the comparison position of the SVL 2300 by one to set the comparison position to “1”.

Step 1-2: Next, the common SVL creating unit 101 compares the value “Bob” stored at the position “0” of the SVL 1300 with the value “Bob” stored at the position “1” of the SVL 2300. In this case, because the values are identical, the common SVL creating unit 101 stores “Bob” in the newSVL 3100 and stores the storage position “1” in the conversion array 1400 (Conv0) and the conversion array 2400 (Conv1). Then, the common SVL creating unit 101 lowers the comparison position of the SVL 1300 by one to set “1” and lowers the comparison position of the SVL 2300 by one to set “2”.

Step 1-3: Next, the common SVL creating unit 101 compares the value “Dolly” stored at the position “1” of the SVL 1300 with the value “Cathy” stored at the position “2” of the SVL 2300. In this case, because “Cathy” is a smaller value, the common SVL creating unit 101 stores “Cathy” in the newSVL 3100 and stores the storage position “2” in the conversion array 2400 (Conv1). Then, the common SVL creating unit 101 lowers the comparison position of the SVL 2300 by one to set the comparison position to “3”.

Step 1-4: Next, the common SVL creating unit 101 compares the value “Dolly” stored at the position “1” of the SVL 1300 with the value “Jerry” stored at the position “3” of the SVL 2300. In this case, because “Dolly” is a smaller value, the common SVL creating unit 101 stores “Dolly” in the newSVL 3100 and stores the storage position “3” in the conversion array 1400 (Conv0). Then, the common SVL creating unit 101 lowers the comparison position of the SVL 1300 by one to set the comparison position to “2”.

Step 1-5: Next, the common SVL creating unit 101 compares the value “Tom” stored at the position “2” of the SVL 1300 with the value “Jerry” stored at the position “3” of the SVL 2300. In this case, because “Jerry” is a smaller value, the common SVL creating unit 101 stores “Jerry” in the newSVL 3100 and stores the storage position “4” in the conversion array 2400 (Conv1). Then, the common SVL creating unit 101 lowers the comparison position of the SVL 2300 by one to set the comparison position to “4”. Here, when the comparison position of any one of the SVLs exceeds the size of the SVL, the comparison is terminated.

Step 1-6: Finally, because no value is stored at the position “4” of the SVL 2300, the common SVL creating unit 101 stores the value “Tom” stored at the position “2” of the SVL 1300 in the newSVL 3100 and stores the storage position “5” in the conversion array 1400 (Conv0). Then, the common SVL creating unit 101 lowers the comparison position of the SVL 1300 by one to set the comparison position to “3”.

With this process, the newSVL 3100, which is common in the SVL 1300 and the SVL 2300, is created. When the newSVL 3100 is created, the conversion array 1400 and the conversion array 2400 are created, and are used to convert the NNC 1200 and the NNC 2200, respectively.

Then, the common SVL creating unit 101 converts values of each NNC using a corresponding conversion array.

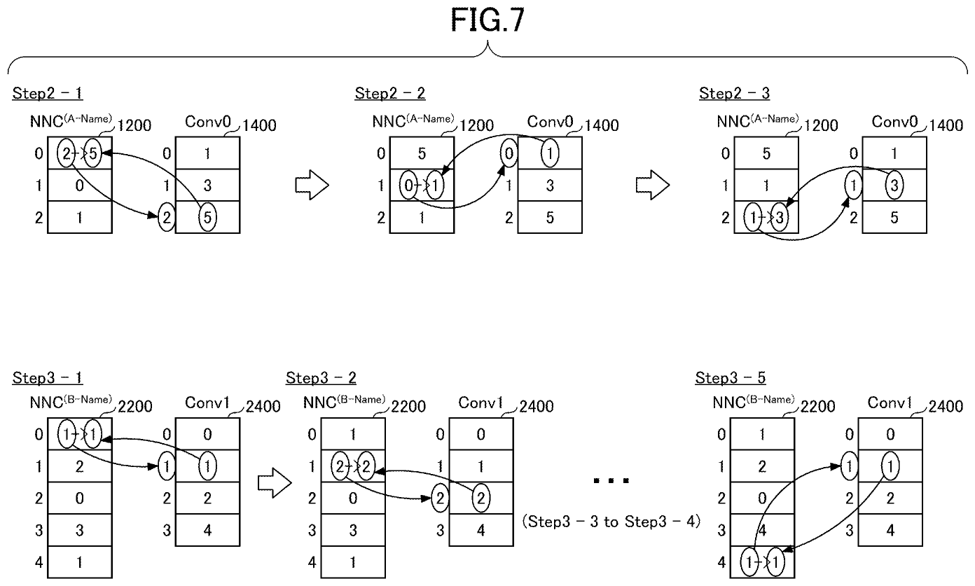

Specifically, as illustrated in FIG. 7, the common SVL creating unit 101 performs Step 2-1 to Step 2-3 and Step 3-1 to Step 3-5.

Step 2-1: First, the common SVL creating unit 101 updates the value “2” stored at the position “0” of the NNC 1200 with the value “5” stored at the position of the value “2” in the conversion array 1400. This updates the value “2” stored at the position “0” of the NNC 1200 to “5”.

Step 2-2: Next, the common SVL creating unit 101 updates the value “0” stored at the position “1” of the NNC 1200 with the value “1” stored at the position of the value “0” in the conversion array 1400. This updates the value “0” stored at the position “1” of the NNC 1200 to “1”.

Step 2-3: Then, the common SVL creating unit 101 updates the value “1” stored at the position “2” of the NNC 1200 with the value “3” stored at the position of the value “1” in the conversion array 1400. This updates the value “1” stored at the position “2” of the NNC 1200 to “3”.

Step 3-1: First, the common SVL creating unit 101 updates the value “1” stored at the position “0” of the NNC 2200 with the value “1” stored at the position of the value “1” in the conversion array 2400. This updates the value “1” stored at the position “0” of the NNC 1200 to “1”.

Step 3-2: Next, the common SVL creating unit 101 updates the value “2” stored at the position “1” of the NNC 2200 with the value “2” stored at the position of the value “2” in the conversion array 2400. This updates the value “2” stored at the position “1” of the NNC 1200 to “2”.

Step 3-3: Next, the common SVL creating unit 101 updates the value “0” stored at the position “2” of the NNC 2200 with the value “0” stored at the position of the value “0” of the conversion array 2400. This updates the value “0” stored at the position “2” of the NNC 1200 to “0”.

Step 3-4: Next, the common SVL creating unit 101 updates the value “3” stored at the position “3” of the NNC 2200 with the value “4” stored at the position of the value “3” in the conversion array 2400. This updates the value “3” stored at the position “3” of the NNC 1200 to “4”.

Step 3-5: Then, the common SVL creating unit 101 updates the value “1” stored at the position “4” of the NNC 2200 with the value “1” stored at the position of the value “1” in the conversion array 2400. This updates the value “1” stored at the position “4” of the NNC 1200 to “1”.

With this process, the NNC 1200 and the NNC 2200 are respectively converted by the conversion array 1400 and the conversion array 2400. The NNC 1200 and the NNC 2200 after the conversion are respectively referred to as a newNNC 1210 and a newNNC 2210.

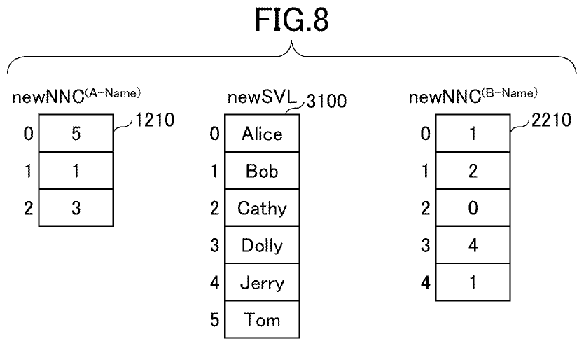

As described above, the newSVL 3100, the newNNC 1210 and the newNNC 2210 illustrated in FIG. 8 are obtained. The newSVL 3100, the newNNC 1210, and the newNNC 2210 are the results of the common SVL creating process, and by using this result, join for two tables and various calculations for a join table can be achieved at high speed.

[Join]

Join for two tables will be described. Join is an operation of virtually combining two tables to create one table, and is mainly classified into two types: inner join and outer join. Here, join may be referred to as “virtual join” or the like to indicate that two tables are virtually combined.

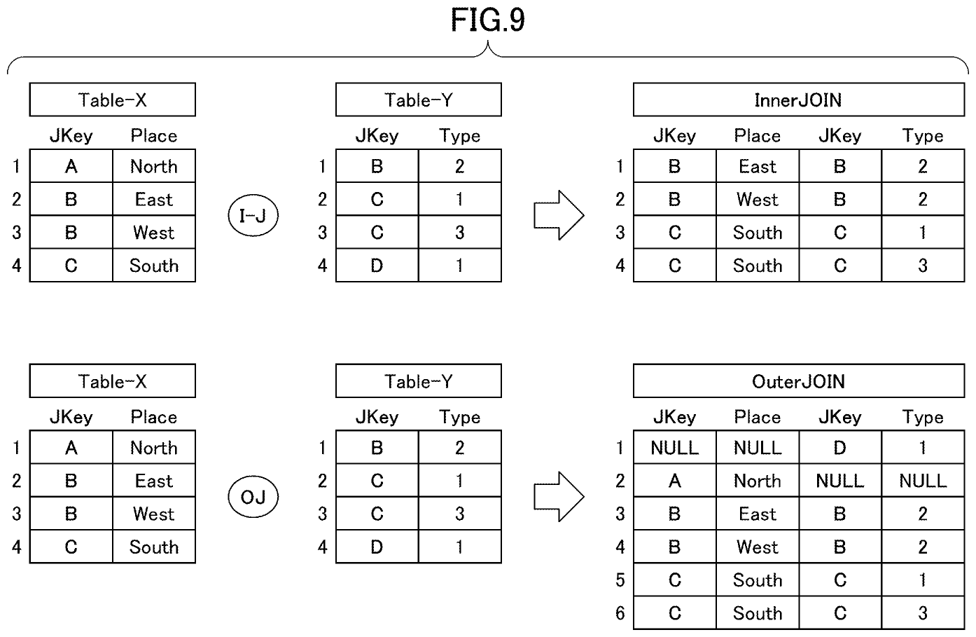

In inner join, for example, as illustrated in the upper part of FIG. 9, the records in both the left and right tables appear in the join table, only when there is a record that matches a record in the opposite table with respect to a join key (JKey). However, the number of appearances is not limited to one.

In outer join, for example, as illustrated in the lower part of FIG. 9, the records in both the left and right tables appear in the join table regardless of whether there is a record that matches in the opposite table with respect to the join key (JKey). However, the number of appearances is not limited to one. Additionally, “NULL” is set in a column of the table on the side where a join key to be matched is not present.

Hereinafter, among the tables on which join is to be performed, a table whose record order is maintained in the join table is referred to as a “master-side table” or a “master side”. With respect to the above, a table whose record order is not necessarily maintained in the join table is referred to as a “slave-side table” or a “slave side”. In the example illustrated in FIG. 9, Table-X is the master side, and Table-Y is the slave side.

In outer join, because with respect to a record having a join key value that is present only on the slave side, the position of the record in the join table is not determined, the record is usually arranged in order from the head or the tail. In the example illustrated in FIG. 9, a record having a join key value “D” that is present only in Table-Y is arranged at the head of the join table.

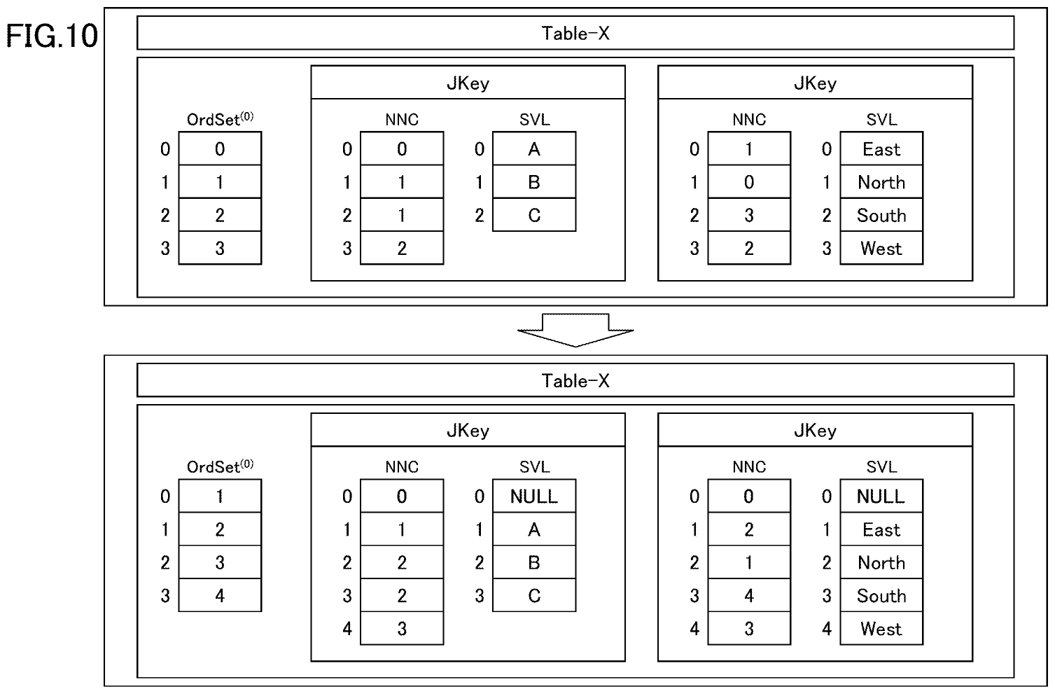

As illustrated in FIG. 9, in outer join, “NULL” is set in the column of the table on the side where there is no matched join key. For this reason, it is convenient to include a NULL record in advance in a table on which join is to be performed. Therefore, in the present embodiment, as illustrated in FIG. 10, the OrdSet of the NNI format table on which join is to be performed is started from “1”, “0” is added to the head of the NNC, and “NULL” is added to the position “0” of the SVL. By changing the method of representing the NNI format in such a way, “NULL” is hidden and cannot be seen before join, but “NULL” can be used in the join table as necessary.

Here, because the SVL stores the respective values in ascending order, NULL needs to be the minimum value. Therefore, actually, when the value stored in the SVL is an integer, 2⁶³ may be used as NULL, when it is a floating point value, −∞ may be used as NULL, and when it is a character string, a null character may be used as NULL.

Because the join table is a virtual combination of two tables, it is not possible to process or edit data, but operations such as searching, sorting, and aggregating can be performed at high speed. This is because even a large number of records (for example, several billions of records) that are difficult to operate in a real table due to memory shortage or the like are virtually combined and can be operated with the number of records on the real table.

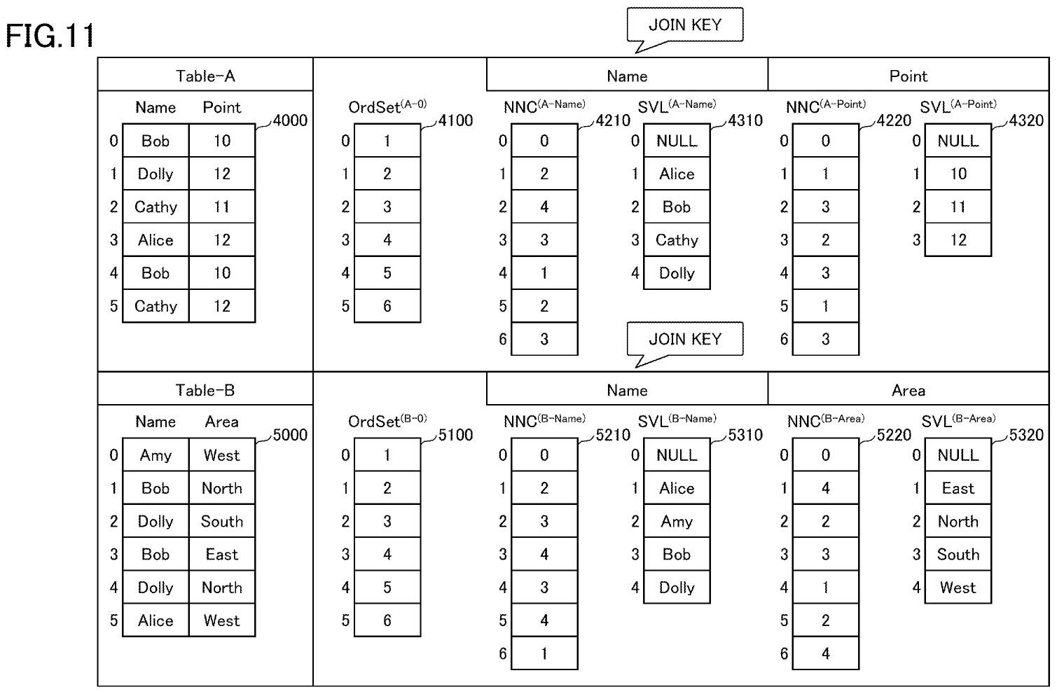

(Inner join) In the following, a case where inner join (more precisely, left inner join) is performed using the join key “Name” on a table 4000 (Table-A) and a table 5000 (Table-B) illustrated in FIG. 11 to create a join table will be described. Here, the table 4000 is decomposed into components: an OrdSet 4100 (OrdSet^{(A-0)}), an NNC 4210 (NNC^{(A-Name)}), an SVL 4310 (SVL^{(A-Name)}), an NNC 4220 (NNC^{(A-Point)}), and an SVL 4320 (SVL^{(A-Point)}). Similarly, the table 5000 is decomposed into components: an OrdSet 5100 (OrdSet^{(B-0)}), an NNC 5210 (NNC^{(B-Name)}), an SVL 5310 (SVL^{(B-Name)}), an NNC 5220 (NNC^{(B-Area)}), and an SVL 5320 (SVL^{(B-Area)}).

At this time, by performing the following Step 4-1 to Step 4-3, a join table in which the table 4000 and the table 5000 are combined by inner join is created.

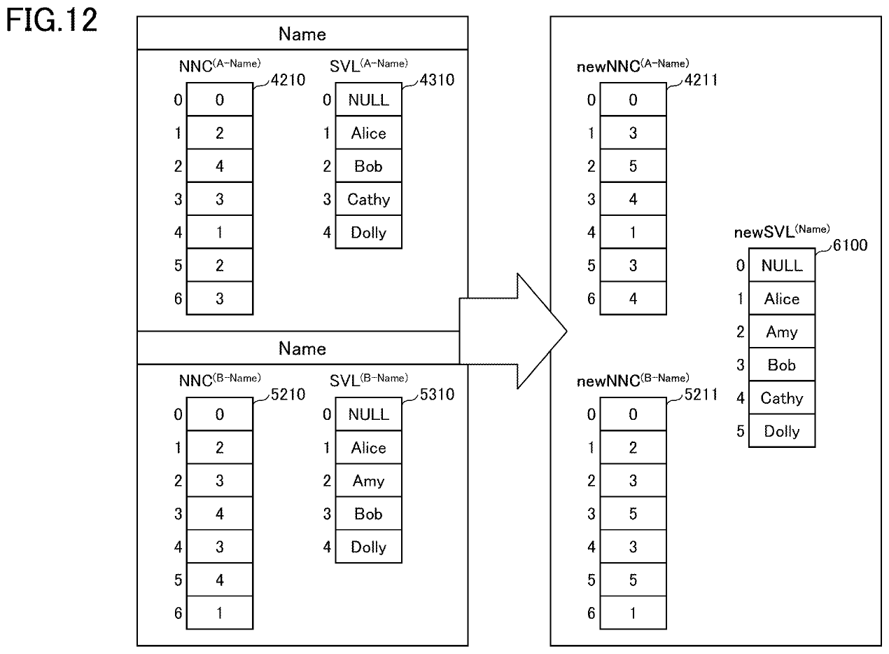

Step 4-1: First, the common SVL creating unit 101 creates a common SVL of the NNI format tables on which join is to be performed by using the SVL and the NNC related to the join key. That is, as illustrated in FIG. 12, the common SVL creating unit 101 uses the NNC 4210 (NNC^{(A-Name)}) and the SVL 4310 (SVL^{(A-Name)}), and the NNC 5210 (NNC^{(B-Name)}) and the SVL 5310 (SVL^{(B-Name)}) to create a common SVL by the above-described common SVL creating process. With this process, a newNNC 4211 (newNNC^{(A-Name)}), a newNNC 5211 (newNNC^{(B-Name)}), and a newSVL 6100 (newSVL^{(Name)}) are created. Hereinafter, the notation “new” may be omitted for the NNC and the SVL created by the common SVL creating process.

Step 4-2: Next, the join creating unit 102 creates an array called a slave-side accumulation array (SAcm) using OrdSet^{(B-0)}. The SAcm is an array storing a value for specifying a position next to an end position of a record group of the slave-side table that corresponds to each join key value when the OrdSet on the slave side is sorted by the join key. This array is also called Aggr, and is called a “slave-side accumulation number array” in Patent Document 1.

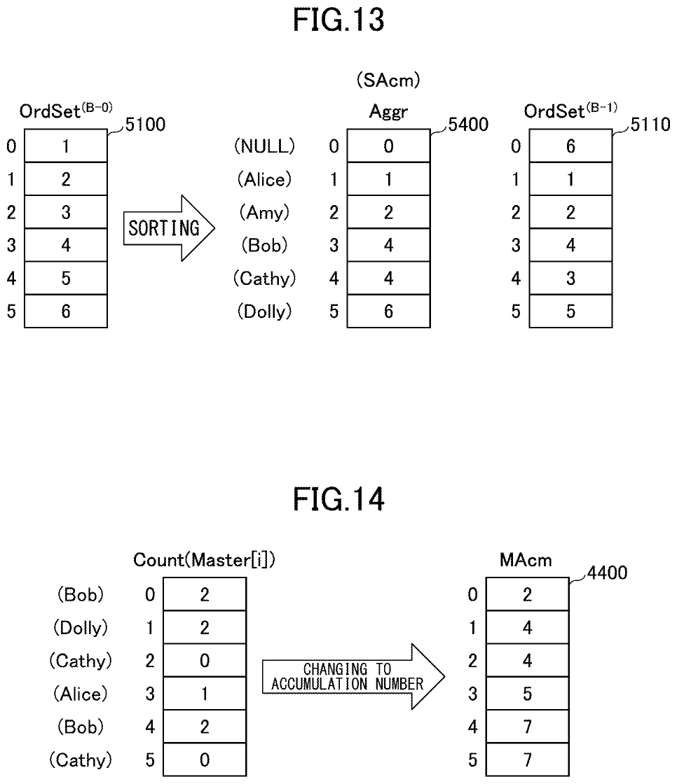

Specifically, as illustrated in FIG. 13, the join creating unit 102 sorts the OrdSet 5100 (OrdSet^{(B-0)}) in ascending order by the join key “Name” to create an OrdSet 5110 (OrdSet^{(B-1)}). The values stored in the OrdSet 5110 (OrdSet^{(B-1)}) represent the join key values “Alice”, “Amy”, “Bob”, “Bob”, “Dolly”, and “Dolly” in this order.

Additionally, the join creating unit 102 prepares an Aggr array 5400 in which “0” is stored at the head, and then sequentially stores the accumulated numbers of the join key values in the Aggr array 5400. With this, an SAcm 5400 is created as the Aggr array 5400. The following numbers are stored in the respective elements of the SAcm 5400.
A 0th element: accumulated number of join key value “NULL”
A first element: accumulated number of join key value “Alice”
A second element: accumulated number of join key values “Alice” and “Amy”
A third element: accumulated number of join key values “Alice” to “Bob”
A fourth element: accumulated number of join key values “Alice” to “Cathy”
A fifth element: accumulated number of join key values “Alice” to “Dolly”
   Therefore, in the slave-side table 5000, the number of records having the i-th join key value: newSVL[i] (the number of appearances) can be calculated by SAcm[i]−SAcm[i−1]. The record number of the record having the i-th join key value: newSVL[i] can be calculated by OrdSet^{(B-1)}[x] for each x that satisfies SAcm[i−1]≤x≤SAcm[i]−1.

Step 4-3: Next, the join creating unit 102 creates an array called a master-side accumulation array (MAcm) using the OrdSet^{(A-0)}, the NNC^{(A-Name)}, and the SAcm. The MAcm is an array representing the accumulated number of repetitions of the join key value of the master-side table in the join table. This array is referred to as a “master-side accumulation number array” in Patent Document 1.

Specifically, the join creating unit 102 calculates Count(Master[i]) as follows.

Count(Master[i])=SAcm[NNC^{(A-Name)}[OrdSet^{(A-0)}[i]]]−SAcm[NNC^{(A-Name)}[OrdSet^{(A-0)}[i]]−1]

The Count(Master[i]) described above represents the number of records in the slave-side table corresponding to the i-th record in the master-side table: Master[i] with respect to the join key. Each Count(Master[i]) for i=0, 1, . . . , 5 is as illustrated in the left part of FIG. 14. This indicates that, for example, two records (the first and third records) of the table 5000 correspond to the 0th record of the table 4000. Similarly, this indicates that two records (the second and fourth records) of the table 5000 correspond to the first record of the table 4000. Similarly, this indicates that there is no record in the table 5000 that corresponds to the third record of the table 4000. The same applies to the others.

Then, the join creating unit 102 sequentially calculates the accumulated number of Count(Master[i]) for i=0, 1, . . . , 5. With this process, a MAcm 4400 is created.

Here, MAcm[i−1] represents an appearance start position of Master[i] in the join table. Additionally, MAcm[i]−MAcm[i−1] represents the repeat count of Master [i] in the join table.

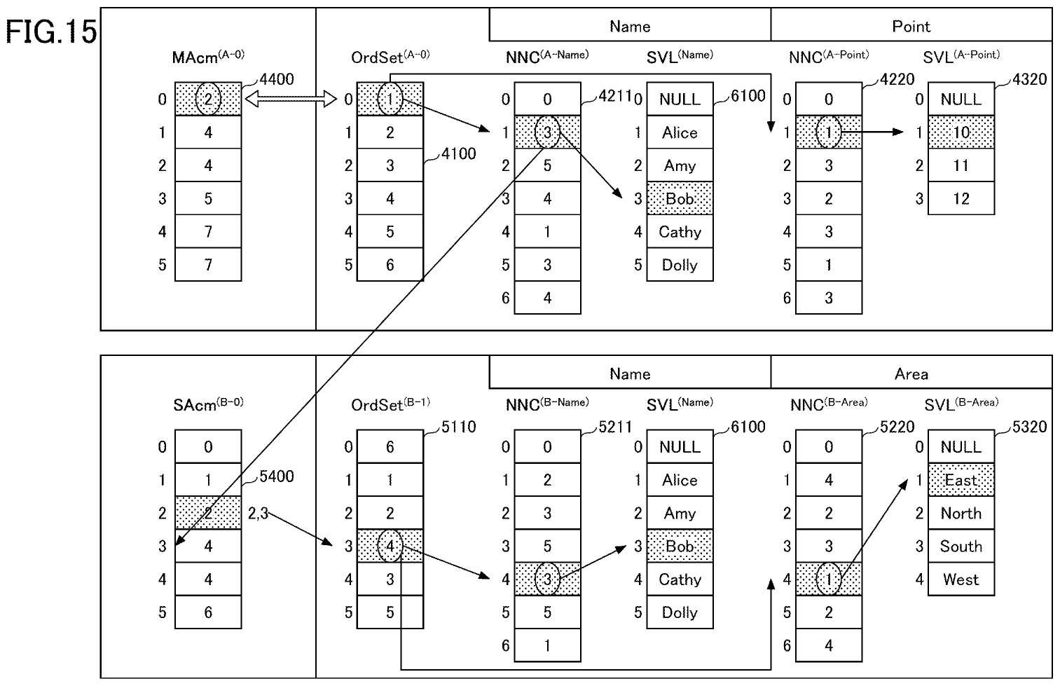

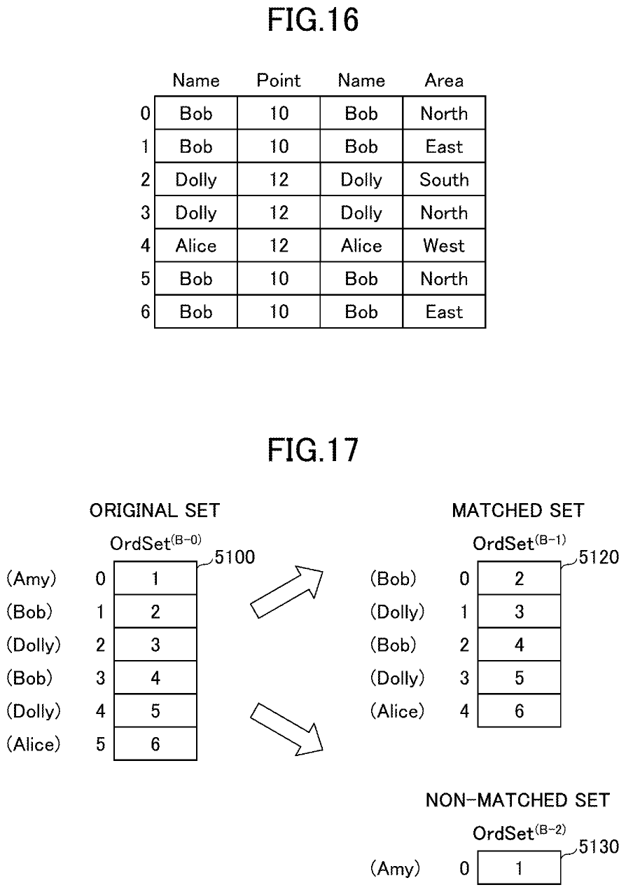

The join table illustrated in FIG. 15 is created by the above-described Step 4-1 to Step 4-3. The join table illustrated in FIG. 15 includes the MAcm 4400, the OrdSet 4100, the NNC 4211, the SVL 6100, the NNC 4220, the SVL 4320, the SAcm 5400, the OrdSet 5110, the NNC 5211, the NNC 5220, and the SVL 5320. FIG. 16 illustrates a tabular representation of the join table.

Here, a case where a record is read from a join table combined by inner join will be described. Because the join table is a virtual table, when a record number I₍ⱼₒᵢₙ₎ of the join table is specified, identifying a record number I₍ₘₐₛₜₑᵣ₎ of the master-side table and a record number I₍ₛₗₐᵥₑ₎ of the slave-side table corresponds to reading the record of the record number I₍ⱼₒᵢₙ₎ from the join table. As an example, a case where the first record (i.e., I₍ⱼₒᵢₙ₎=1) of the join table illustrated in FIG. 16 is read will be described by the following Step 5-1 to Step 5-4 with reference to FIG. 15.

Step 5-1: The join creating unit 102 identifies I₍ₘₐₛₜₑᵣ₎. This can be achieved by obtaining the minimum j that satisfies MAcm[j]>I₍ⱼₒᵢₙ₎ and setting I₍ₘₐₛₜₑᵣ₎=j. Here, the minimum j that satisfies MAcm[j]>I₍ⱼₒᵢₙ₎ may be obtained using, for example, a bisection method. In the join table illustrated in FIG. 15, because MAcm[0] is the minimum j that satisfies MAcm[j]>I₍ⱼₒᵢₙ₎, j=0 is identified, and I₍ₘₐₛₜₑᵣ₎=0 is obtained.

Step 5-2: The join creating unit 102 obtains an offset. The offset is an order starting from 0 among one or more Slave [I₍ₛₗₐᵥₑ₎] corresponding to Master [I₍ₘₐₛₜₑᵣ₎]. Here, Slave[I₍ₛₗₐᵥₑ₎] represents the I₍ₛₗₐᵥₑ₎-th record in the slave side table.

Because MAcm[I₍ₘₐₛₜₑᵣ₎−1] represents the start position of Master[I₍ₘₐₛₜₑᵣ₎] in the join table, the offset is obtained as follows.

offset=I₍ⱼₒᵢₙ₎−MAcm[I₍ₘₐₛₜₑᵣ₎−1]

Therefore, in the join table illustrated in FIG. 15, offset=1 is obtained.

Step 5-3: The join creating unit 102 obtains a base. The base is the start position of one or more Slave [I₍ₛₗₐᵥₑ₎] corresponding to Master [I₍ₘₐₛₜₑᵣ₎] in the OrdSet^{(B-1)}. The base is obtained as follows.

base=SAcm[NNC^{(A-Name)}[OrdSet^{(A-0)}[I₍ₘₐₛₜₑᵣ₎]]−1]

Therefore, in the join table illustrated in FIG. 15, base=2 is obtained.

Step 5-4: The join creating unit 102 obtains I₍ₛₗₐᵥₑ₎ as follows.

I₍ₛₗₐᵥₑ₎=base+offset

Therefore, in the join table illustrated in FIG. 15, I₍ₛₗₐᵥₑ₎=3 is obtained.

As described above, because I₍ₘₐₛₜₑᵣ₎ and I₍ₛₗₐᵥₑ₎ are identified for I₍ⱼₒᵢₙ₎, when the i-th record in the join table is represented as Join[i], the record can be read by Join [I₍ⱼₒᵢₙ₎]=Master [I₍ₘₐₛₜₑᵣ₎] & Slave [I₍ₛₗₐᵥₑ₎]. Here, “&” represents a combination of records. For example, the record can be read as follows: Join[I₍ⱼₒᵢₙ₎=1]=Master[I₍ₘₐₛₜₑᵣ₎] & Slave[I₍ₛₗₐᵥₑ₎]=Master [0] & Slave [3]=(Bob, 10) & (Bab, East).

(Outer Join)

In the following, a case in which an outer join (more accurately, a full outer join) is performed with the join key “Name” on the table 4000 (Table-A) and the table 5000 (Table-B) illustrated in FIG. 11 to create a join table will be described.

Here, full outer join corresponds to three join operations of inner join, left outer join, and right outer join. In left outer join, with respect to a master-side record having no corresponding slave-side record, NULL is set in the slave-side column while the order of the master-side record having no corresponding slave-side record is maintained. In right outer join, with respect to a slave-side record that does not have a corresponding master-side record, the slave-side record that does not have a corresponding master-side record is moved to the head (or the end), and then NULL is set in the master-side column.

At this time, by performing the following Step 6-1 to Step 6-3, a join table in which the table 4000 and the table 5000 are combined by outer join is created.

Step 6-1: First, the common SVL creating unit 101 creates a common SVL of the NNI format tables on which join is to be performed, using the SVL and the NNC related to the join key as in Step 4-1 described above.

Step 6-2: Next, the join creating unit 102 creates an SAcm using the OrdSet^{(B-0)}. Specifically, the join creating unit 102 creates the SAcm by the following (1-1) to (1-3).

(1-1) First, as illustrated in FIG. 17, the join creating unit 102 separates the OrdSet 5100 into a matched set in join (i.e., a set of one or more values of the join key, each of which in one table among the master-side table and the slave-side table matches a value in the other table) and an unmatched set in join (i.e., a set of one or more values of the join key, each of which in one table among the master-side table and the slave-side table does not match any value in the other table). At this time, NULL in the join key on the slave side is also included in the unmatched set. This is because there is a custom that NULL does not match any value. Hereinafter, the matched set is referred to as an OrdSet 5120 (OrdSet^{(B-1)}, and the unmatched set is referred to as an OrdSet 5130 (OrdSet^{(B-2)}). The operation of extracting the matched set in join and the unmatched set in join will be described later in detail.

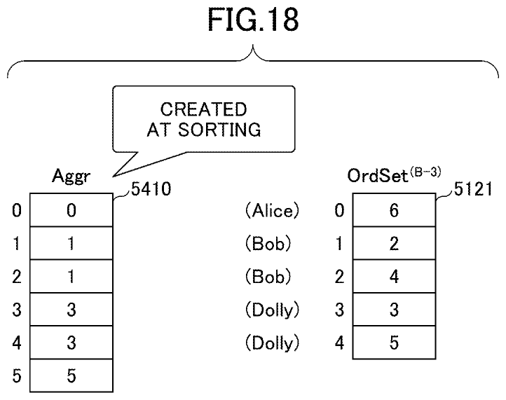

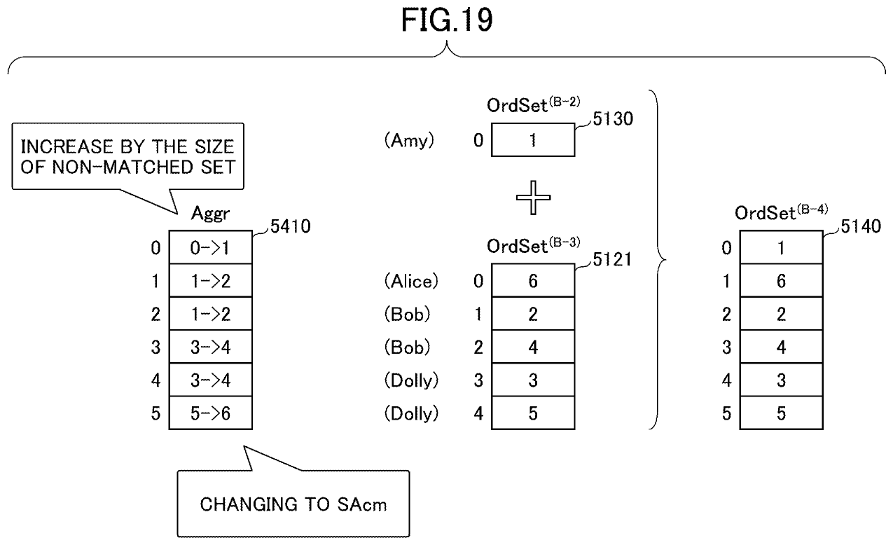

(1-2) Next, as illustrated in FIG. 18, the join creating unit 102 sorts the OrdSet 5120 (OrdSet^{(B-1)}), which is the matched set in join, to create an OrdSet 5121 (OrdSet^{(B-3)}). Additionally, at this time, the join creating unit 102 creates an Aggr 5410. As described above, the Aggr 5410 is created by storing “0” at the head and then sequentially storing the accumulated number of the join key values.

(1-3) Then, as illustrated in FIG. 19, the join creating unit 102 add the number of elements (size) of the OrdSet 5130 to each of the elements of the Aggr 5410, and the OrdSet 5130 and the OrdSet 5121 are combined to create an OrdSet 5140 (OrdSet^{(B-4)}). The Aggr 5410 after the number of elements of the OrdSet 5130 is added becomes an SAcm 5410. Here, the OrdSet 5140 is a sort set of the slave side table.

Step 6-3: Next, the join creating unit 102 creates a MAcm by using the OrdSet^{(A-0)}, the NNC^{(A-Name)}, and the SAcm.

Specifically, the join creating unit 102 creates the MAcm by the following (2-1) to (2-3).

(2-1) First, the join creating unit 102 calculates Count(Master[i]) as follows.

Count(Master[i])=SAcm[NNC^{(A-Name)}[OrdSet^{(A-0)}[i]]]−SAcm[NNC^{(A-Name)}[OrdSet^{(A-0)}[i]]−1]

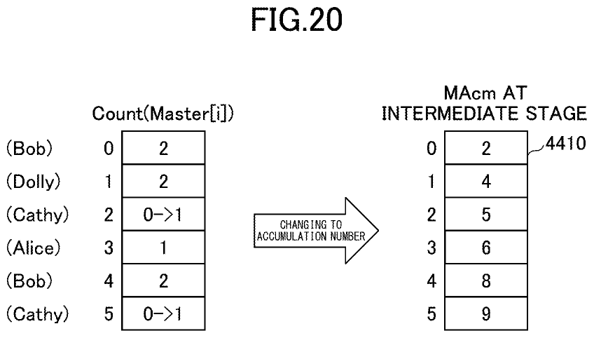

(2-2) Next, as illustrated in FIG. 20, the join creating unit 102 adds “1” when Count(Master[i])=0. Then, the join creating unit 102 sequentially calculates the accumulated number of Count(Master[i]) for i=0, 1, . . . , 5. With this process, an intermediate stage MAcm 4410 is created.

Here, 1 is added when Count(Master[I])=0 in order to achieve left outer join. In the example illustrated in FIG. 20, by adding 1 to each of Count(Master[2]) and Count(Master[5]), the record having the join key value “Cathy” does not disappear, and the record remains in the join table, and left outer join can be achieved.

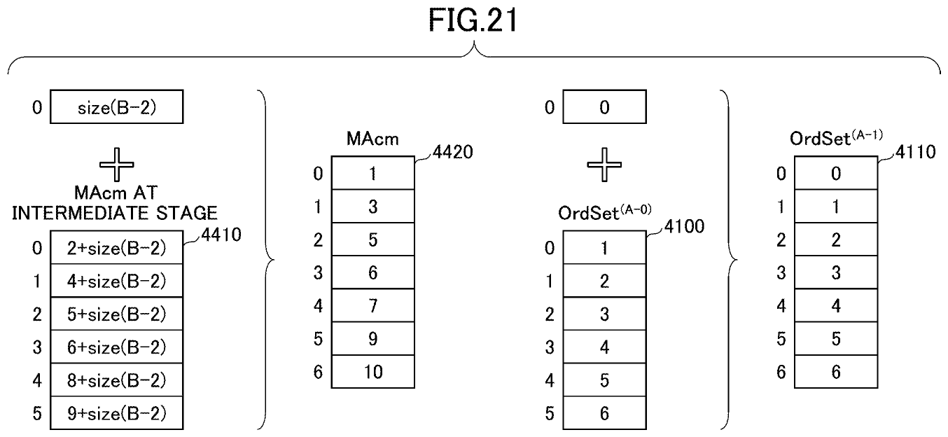

(2-3) Then, as illustrated in FIG. 21, the join creating unit 102 creates a final MAcm 4420 from the intermediate stage MAcm 4410 and creates an OrdSet 4110 (OrdSet^{(A-1)}) from the OrdSet 4100. Here, when the size of the OrdSet 5130, which is the unmatched set in join, is represented by “size(B-2)”, the MAcm 4420 is created by adding “size(B-2)” to the head of the intermediate stage MAcm 4410 and then adding “size(B-2)” to each of the elements. Here, “size(B-2)=1” at the head of the MAcm 4420 represents the number of repeats of a record in which NULL is set.

With respect to the above, the OrdSet 4110 is created by adding “0” to the head of the OrdSet 4100. Here, “0” at the head of the OrdSet 4110 indicates that NULL is set in the master-side record.

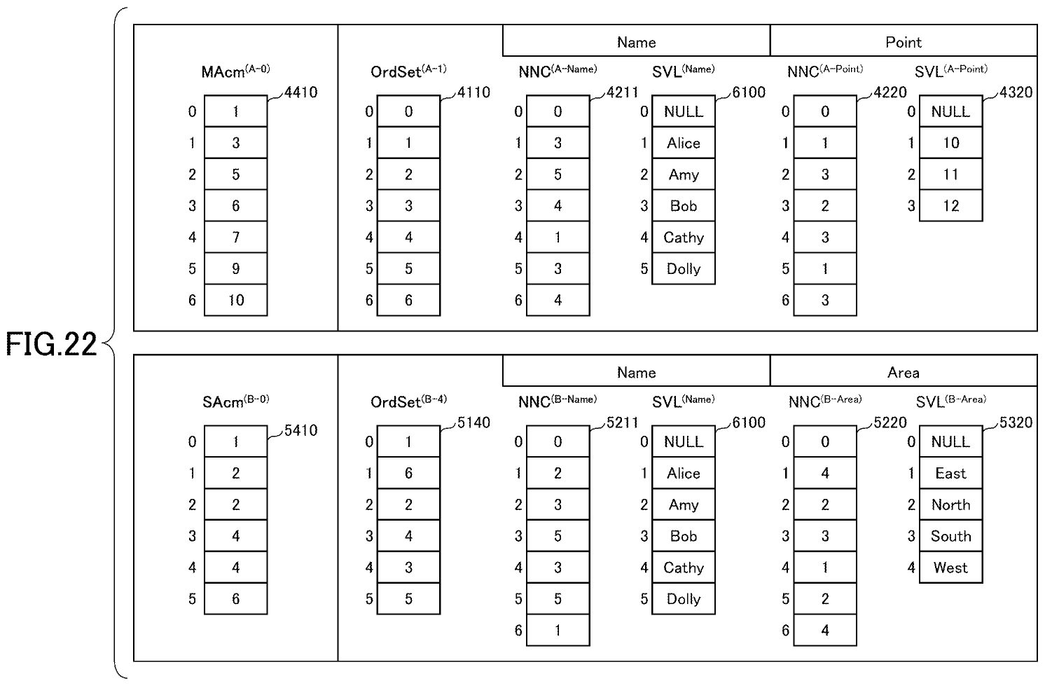

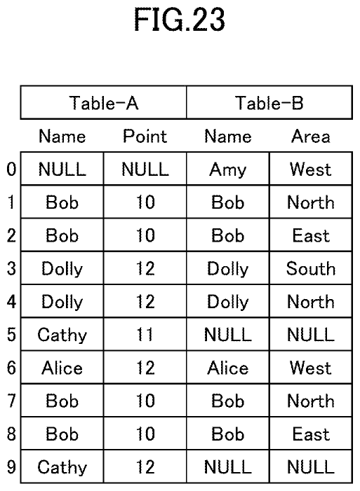

The join table illustrated in FIG. 22 is created by the above-described Step 6-1 to Step 6-3. The join table illustrated in FIG. 22 includes the MAcm 4410, the OrdSet 4110, the NNC 4211, the SVL 6100, the NNC 4220, the SVL 4320, the SAcm 5410, the OrdSet 5140, the NNC 5211, the NNC 5220, and the SVL 5320. FIG. 23 illustrates a tabular representation of the join table.

Here, a case where a record is read from the join table combined by outer join will be described. The join table combined by outer join includes records combined by right outer join, records joined by left outer join, and records joined by inner join. In the following, reading of each record will be described.

Reading of the Right Outer Join Portion

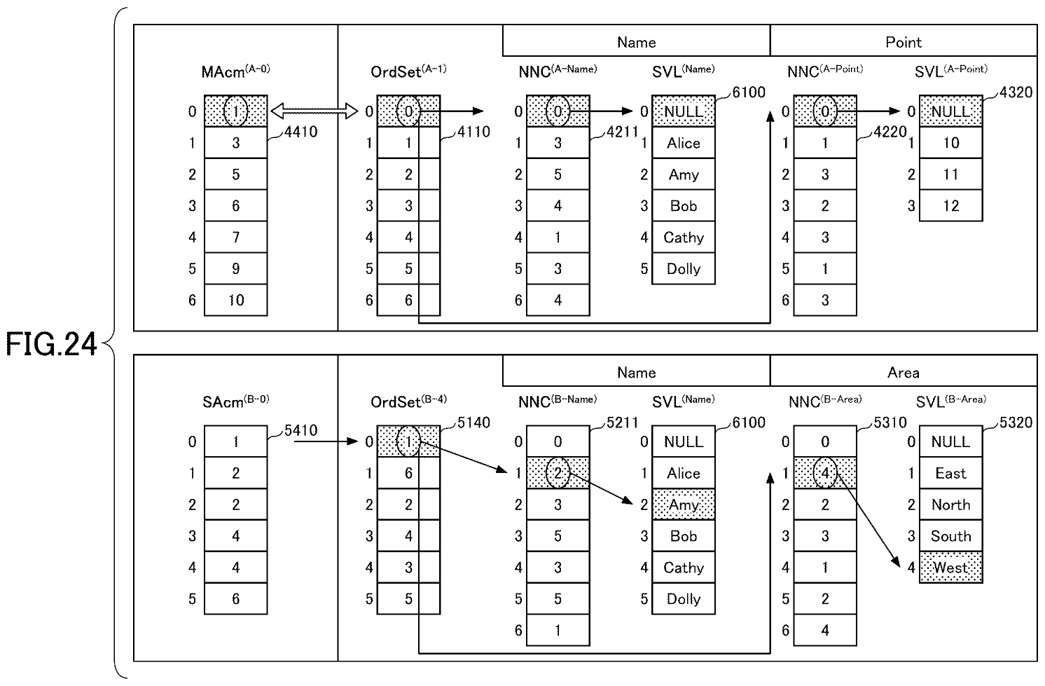

As an example, a case where the 0th record (i.e., I₍ⱼₒᵢₙ₎=0) of the join table illustrated in FIG. 23 is read will be described by the following Step 7-1 to Step 7-2 with reference to FIG. 24.

Step 7-1: The join creating unit 102 identifies I₍ₘₐₛₜₑᵣ₎. This can be achieved by obtaining the minimum j that satisfies MAcm[j]>I₍ⱼₒᵢₙ₎ and setting I₍ₘₐₛₜₑᵣ₎=j. Here, the minimum j that satisfies MAcm[j]>I₍ⱼₒᵢₙ₎ may be obtained using, for example, a bisection method. As illustrated in FIG. 24, in the join table illustrated in FIG. 22, because MAcm[0] is the minimum j that satisfies MAcm[j]>I₍ⱼₒᵢₙ₎, j=0 is identified, and I₍ₘₐₛₜₑᵣ₎=0 is obtained.

Step 7-2: The join creating unit 102 checks whether the record of I₍ⱼₒᵢₙ₎=0 is a right outer join portion. This can be done by checking whether OrdSet^{(A-1)}[I₍ₘₐₛₜₑᵣ₎]=0 is established. If OrdSet^{(A-1)}[I₍ₘₐₛₜₑᵣ₎]=0 is established, the record of I₍ⱼₒᵢₙ₎ is a record combined by right outer join, and I₍ₛₗₐᵥₑ₎=I₍ⱼₒᵢₙ₎.

As illustrated in FIG. 24, because OrdSet^{(A-1)}[0]=0 is established in the join table illustrated in FIG. 22, the record of I₍ⱼₒᵢₙ₎=0 is a record combined by right outer join, and I₍ₛₗₐᵥₑ₎=I₍ⱼₒᵢₙ₎=0.

As described, Join[I₍ⱼₒᵢₙ₎=0]=Master[I₍ₘₐₛₜₑᵣ₎] & Slave[I₍ₛₗₐᵥₑ₎]=Master[0] & Slave[0]=(NULL, NULL) & (Amy, West) can be read.

Reading of the Left Outer Join Portion

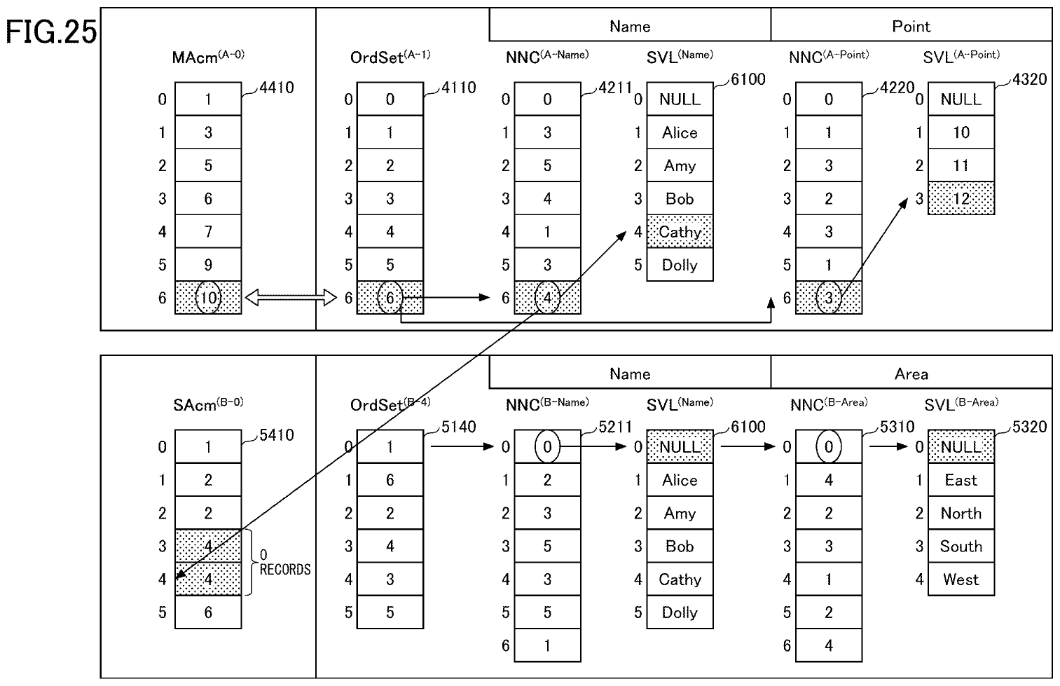

As an example, a case where the ninth record (i.e., I₍ⱼₒᵢₙ₎=9) in the join table illustrated in FIG. 23 is read will be described by the following Step 8-1 to Step 8-3 with reference to FIG. 25.

Step 8-1: The join creating unit 102 identifies I₍ₘₐₛₜₑᵣ₎. As illustrated in FIG. 25, in the join table illustrated in FIG. 22, because MAcm[6] is the minimum j that satisfies MAcm[j]>I₍ⱼₒᵢₙ₎, j=6 is identified, and I₍ₘₐₛₜₑᵣ₎=6 is obtained.

Step 8-2: The join creating unit 102 checks whether the record of I₍ⱼₒᵢₙ₎=9 is a right outer join portion. As illustrated in FIG. 25, because OrdSet^{(A-1)}[I₍ₘₐₛₜₑᵣ₎]=6 in the join table illustrated in FIG. 22, the record of I₍ⱼₒᵢₙ₎=9 is not a record combined by right outer join.

Step 8-3: The join creating unit 102 checks whether the record of I₍ⱼₒᵢₙ₎=9 is a left outer join portion. This can be done by checking whether Count(Master[I₍ₘₐₛₜₑᵣ₎])=0 is established. When Count(Master[I₍ₘₐₛₜₑᵣ₎])=0 is established, the record of I₍ⱼₒᵢₙ₎ is a record combined by left outer join, and in this case, although I₍ₛₗₐᵥₑ₎ is not present, the value on the slave side becomes NULL (that is, SVL[0]).

As illustrated in FIG. 25, in the join table illustrated in FIG. 22, Count(Master[6])=SAcm[NNC^{(A-Name)}[OrdSet^{(A-1)}[6]]]−SAcm[NNC^{(A-Name)}[OrdSet^{(A-1)}[6]−1]=4−4=0 is obtained. Therefore, the record of I₍ⱼₒᵢₙ₎=9 is a record combined by left outer join.

As described, Join [I₍ⱼₒᵢₙ₎=9]=Master [I₍ₘₐₛₜₑᵣ₎] & (NULL, NULL)=(Cathy, 12) & (NULL, NULL) can be read.

Reading of an Inner Join Portion

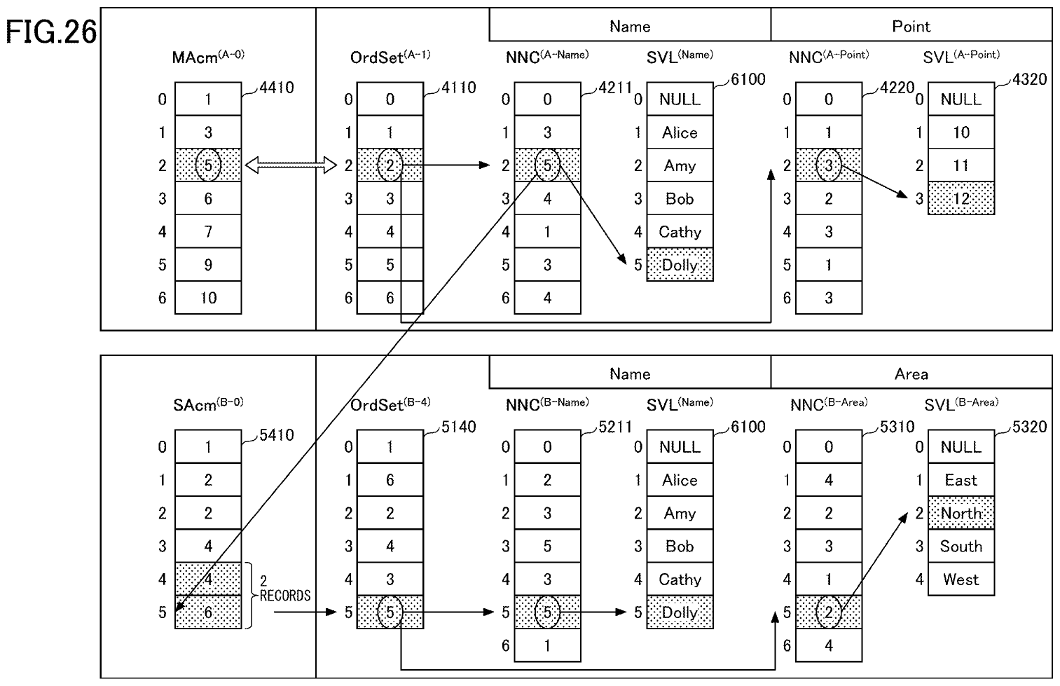

As an example, a case where the fourth record (i.e., I₍ⱼₒᵢₙ₎=4) in the join table illustrated in FIG. 23 is read will be described by the following Step 9-1 to Step 9-6 with reference to FIG. 26.

Step 9-1: The join creating unit 102 identifies I₍ₘₐₛₜₑᵣ₎. As illustrated in FIG. 26, in the join table illustrated in FIG. 22, because MAcm[2] is the minimum j that satisfies MAcm[j]>I₍ⱼₒᵢₙ₎, j=2 is identified, and I₍ₘₐₛₜₑᵣ₎=2 is obtained.

Step 9-2: The join creating unit 102 checks whether the record of I₍ⱼₒᵢₙ₎=4 is a right outer join portion. As illustrated in FIG. 26, because OrdSet^{(A-1)}[I₍ₘₐₛₜₑᵣ₎]=2 in the join table illustrated in FIG. 22 is obtained, the record of I₍ⱼₒᵢₙ₎=4 is not a record combined by right outer join.

Step 9-3: The join creating unit 102 checks whether the record of I₍ⱼₒᵢₙ₎=4 is a left outer join portion. As illustrated in FIG. 26, in the join table illustrated in FIG. 22, Count(Master[2])=SAcm [NNC^{(A-Name)}[OrdSet^{(A-1)}[2]]]−SAcm[NNC^{(A-Name)}[OrdSet^{(A-1)}[2]]−1]=6−4=2 is obtained. Therefore, the record of I₍ⱼₒᵢₙ₎=4 is not a record combined by left outer join.

Step 9-4: The join creating unit 102 obtains offset=1 from offset=I₍ⱼₒᵢₙ₎−MAcm[I₍ₘₐₛₜₑᵣ₎−1].

Step 9-5: The join creating unit 102 obtains base=4 from base=SAcm[NNC^{(A-Name)}[OrdSet^{(A-1)}[I₍ₘₐₛₜₑᵣ₎]]−1].

Step 9-6: The join creating unit 102 obtains I₍ₛₗₐᵥₑ₎=5 from I₍ₛₗₐᵥₑ₎=base+offset.

As described, Join[I₍ⱼₒᵢₙ₎=4]=Master [I₍ₘₐₛₜₑᵣ₎] & Slave[I₍ₛₗₐᵥₑ₎]=Master[2] & Slave[5]=(Dolly, 12) & (Dolly, North) can be read.

(When Multiple Columns are Used as Join Keys)

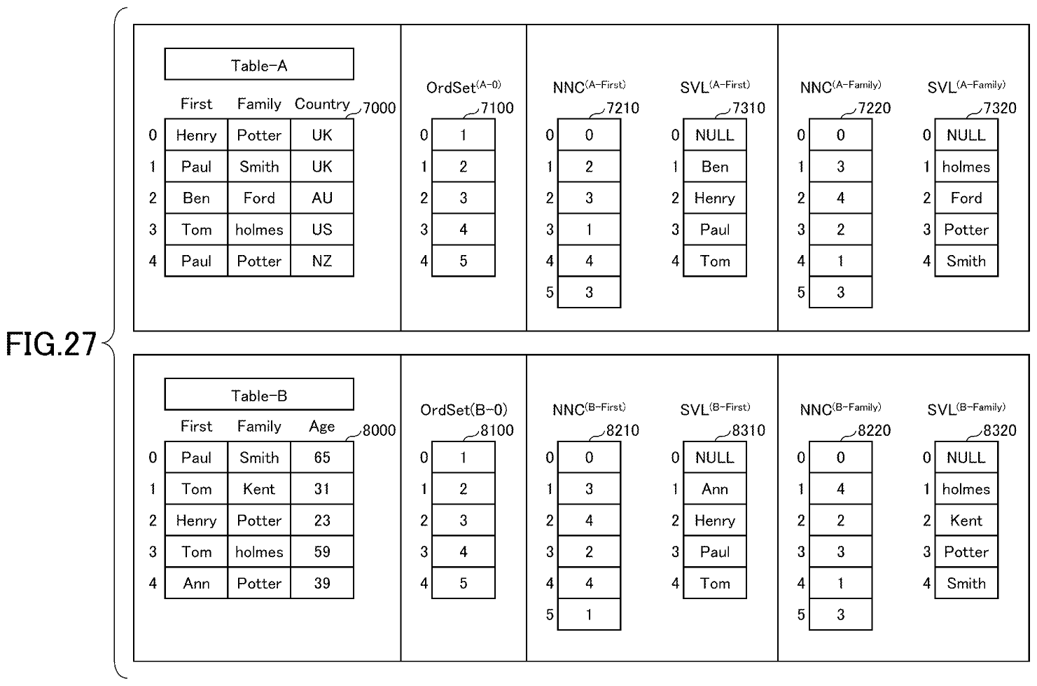

There is a case where it is desired to create a join table using multiple columns as join keys. Therefore, in the following, a case where join is performed on a table 7000 (Table-A) and a table 8000 (Table-B) illustrated in FIG. 27, using the join keys “First” and “Family” to create a join table.

Here, the table 7000 is decomposed into components: an OrdSet 7100 (OrdSet^{(A-0)}), an NNC 7210 (NNC^{(A-First)}), an SVL 7310 (SVL^{(A-First)}), an NNC 7220 (NNC^{(A-Family)}), and an SVL 7320 (SVL^{(A-Family)}). Here, the table 7000 is also decomposed into components: an NNC^{(A-Country)} and an SVL^{(A-Country)} with respect to the column “Country”, but illustration thereof is omitted.

Similarly, the table 8000 is decomposed into components: an OrdSet 8100 (OrdSet^{(B-0)}), an NNC 8210 (NNC^{(B-First)}), an SVL 8310 (SVL^{(B-First)}), an NNC 8220 (NNC^{(B-Family)}) and an SVL 8320 (SVL^{(B-Family)}). Here, the table 8000 is also decomposed into components: an NNC^{(B-Age)} and an SVL^{(B-Age)} with respect to the column “Age”, but illustration thereof is omitted.

At this time, first, by performing the following Step 10-1 to Step 10-5, a join table using multiple columns as join keys is created.

Step 10-1: First, the common SVL creating unit 101 creates a common SVL of the NNI format tables on which join is to be performed for each join key by using the SVL and the NNC related to the join key.

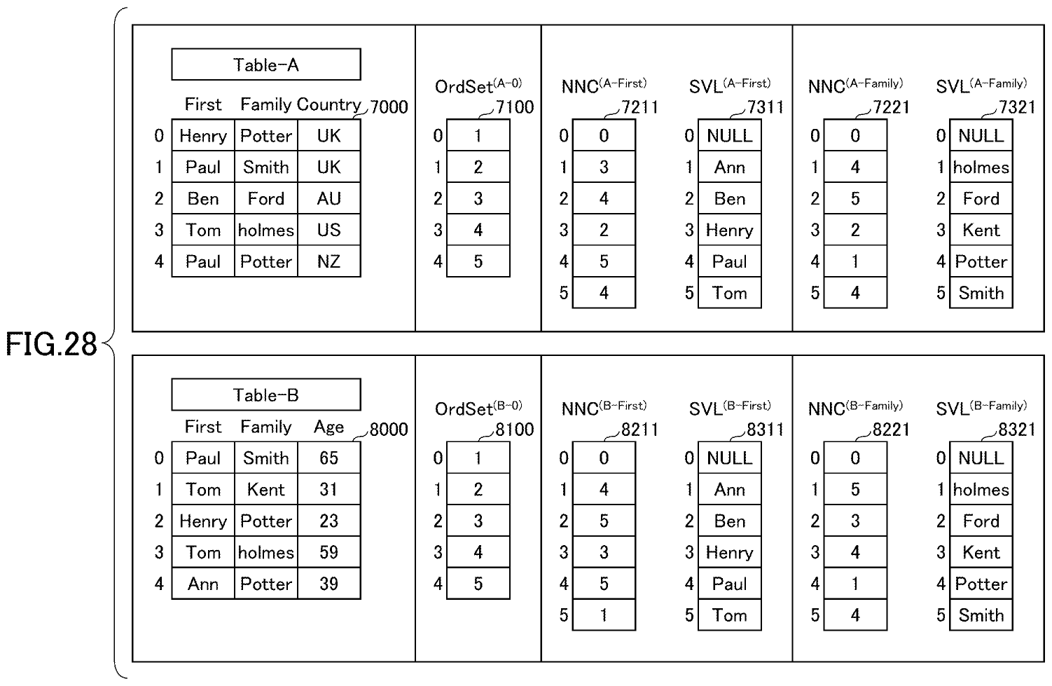

That is, the common SVL creating unit 101 uses the NNC 7210 (NNC^{(A-First)}) and the SVL 7310 (SVL^{(A-First)}), and the NNC 8210 (NNC^{(B-First)}) and the SVL 8310 (SVL^{(B-First)}) to create a common SVL by the above-described common SVL creating process. With this process, as illustrated in FIG. 28, an NNC 7211 (NNC^{(A-First)}) and an SVL 7311 (SVL^{(A-First)}), and an NNC 8211 (NNC^{(B-First)}) and an SVL 8311 (SVL^{(B-First)}) are created. Here, the SVL 7311 and the SVL 8311 are the common SVL with respect to the column “First”.

Similarly, the common SVL creating unit 101 uses the NNC 7220 (NNC^{(A-Family)}) and the SVL 7320 (SVL^{(A-Family)}), and the NNC 8220 (NNC^{(B-Family)}) and the SVL 8320 (SVL^{(B-Family)}) to create a common SVL by the above-described common SVL creating process. With this process, as illustrated in FIG. 28, an NNC 7221 (NNC^{(A-Family)}) and an SVL 7321 (SVL^{(A-Family)}), and an NNC 8221 (NNC^{(B-Family)}) and an SVL 8321 (SVL^{(B-Family)}) are created. Here, the SVL 7321 and the SVL 8321 are the common SVL with respect to the column “Family”.

Step 10-2: The join creating unit 102 creates an NNI format table used for join. Specifically, the join creating unit 102 creates the NNI format table by the following (3-1) to (3-6).

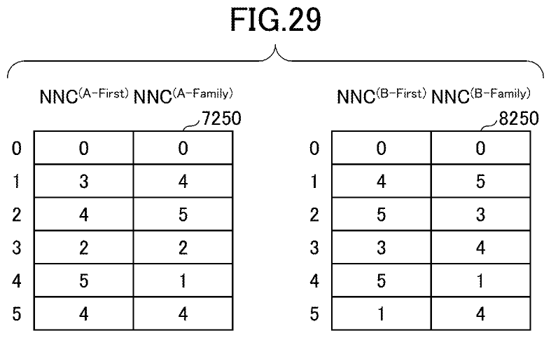

(3-1) First, as illustrated in FIG. 29, the join creating unit 102 creates a multi-key field 7250 in which the NNC 7211 and the NNC 7221 are arranged and a multi-key field 8250 in which the NNC 8211 and the NNC 8221 are arranged. Here, the multi-key field 7250 and the multi-key field 8250 are two-dimensional arrays.

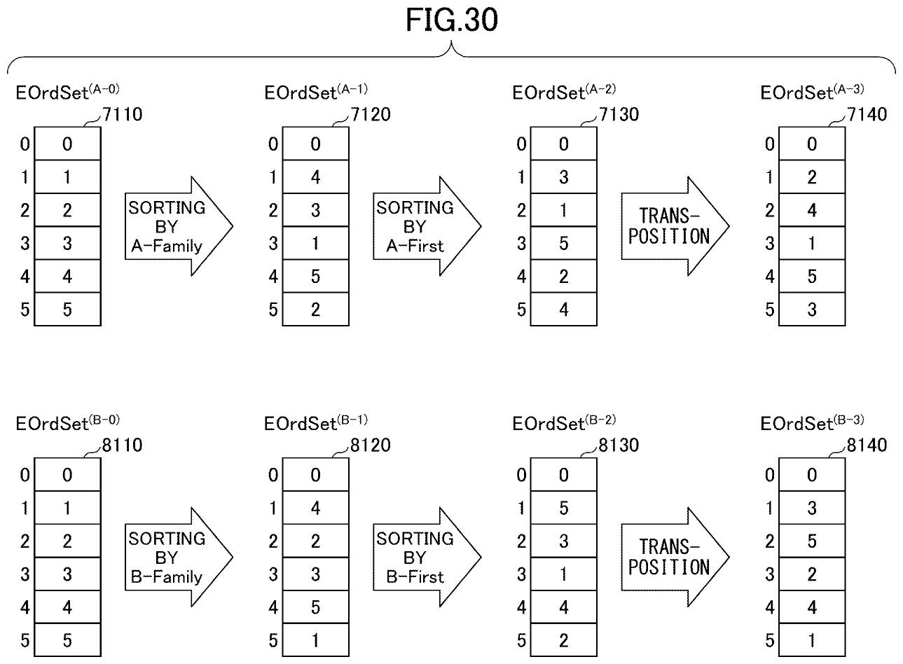

(3-2) Next, as illustrated in FIG. 30, the join creating unit 102 creates an EOrdSet 7110 (EOrdSet^{(A-0)}) and an EOrdSet 8110 (EOrdSet^{(B-0)}). The EOrdSet 7110 and the EOrdSet 8110 are called an extended universal set, and are respectively arrays obtained by adding “0” to the head of the OrdSet 7100 (OrdSet^{(A-0)}) and the OrdSet 8100 (OrdSet^{(B-0)}).

(3-3) Next, as illustrated in FIG. 30, the join creating unit 102 sorts the EOrdSet 7110 by the column “Family” in ascending order to create an EOrdSet 7120 (EOrdSet^{(A-1)}), and then sorts the EOrdSet 7110 by the column “First” in ascending order to create an EOrdSet 7130 (EOrdSet^{(A-2)}). Similarly, the join creating unit 102 sorts the EOrdSet 8110 by the column “Family” in ascending order to create an EOrdSet 8120 (EOrdSet^{(B-1)}), and then sorts the EOrdSet 8110 by the column “First” in ascending order to create an EOrdSet 8130 (EOrdSet^{(B-2)}).

(3-4) Next, as illustrated in FIG. 30, the join creating unit 102 performs a transposition operation on the EOrdSet 7130 to create an EOrdSet 7140 (EOrdSet^{(A-3)}). Similarly, the join creating unit 102 performs a transposition operation on the EOrdSet 8130 to create an EOrdSet 8140 (EOrdSet^{(B-3)}). Here, when i, j=0, . . . , n and A is an array that satisfies A[i]≠A[j] when i≠j, the transposition operation for A refers to an operation of converting A into an array A⁻¹ that satisfies i=A⁻¹[j] when j=A[i].

(3-5) Next, the join creating unit 102 creates an SVL and a Conv array.

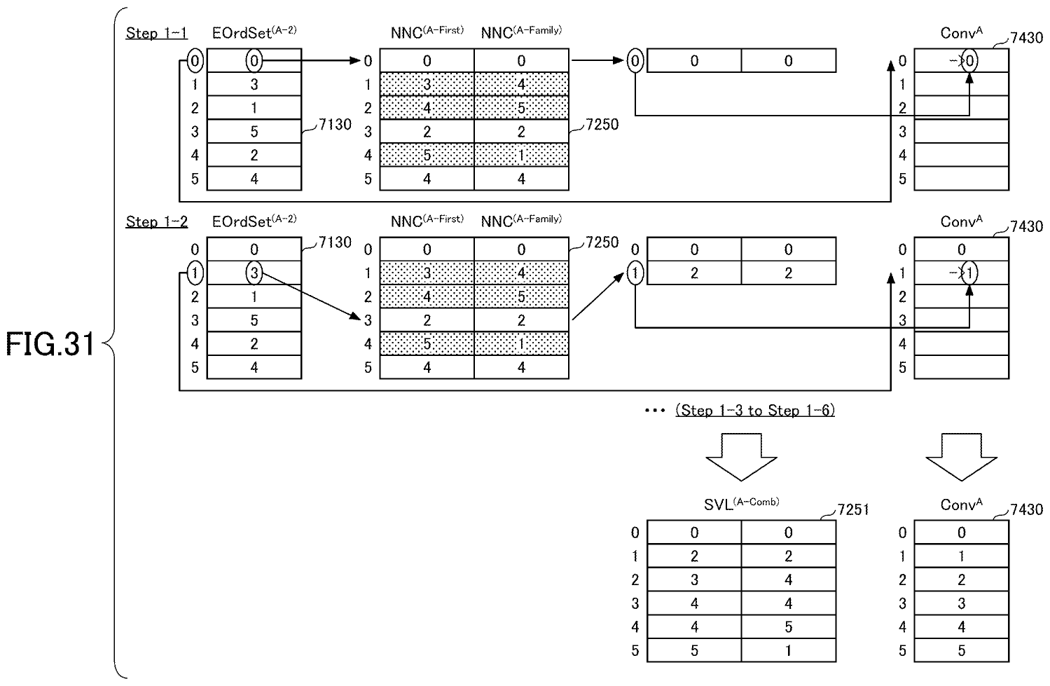

Specifically, the join creating unit 102 creates an SVL 7251 (SVL^{(A-Comb)}) and a Cony 7430 (Conv^{A}) by performing Step 1-1 to Step 1-6 illustrated in FIG. 31. That is, the join creating unit 102 creates the SVL 7251 (SVL^{(A-Comb)}) by outputting the values of the multi-key field 7250 in accordance with the EOrdSet 7130, and sets the output positions of the SVL 7251 in the Conv 7430 (Conv^{A}). However, if the value to be output is the same as the previous value, the value is not output.

Step 1-1: The join creating unit 102 uses the value “0” stored at the position “0” of the EOrdSet 7130 to output the value “(0,0)” at the position “0” of the multi-key field 7250 to the position “0” of the SVL 7251. Additionally, the join creating unit 102 stores the output position “0” in the Conv 7430.

Step 1-2: Next, the join creating unit 102 uses the value “3” stored at the position “1” of the EOrdSet 7130 to output the value “(2, 2)” at the position “3” of the multi-key field 7250 to the position “1” of the SVL 7251. Additionally, the join creating unit 102 stores the output position “1” in the Conv 7430.

Thereafter, the SVL 7251 (SVL^{(A-Comb)}) and the Conv 7430 (Conv^{A}) are created by repeating Step 1-3 to the Step 5, 1-6 in substantially the same manner.

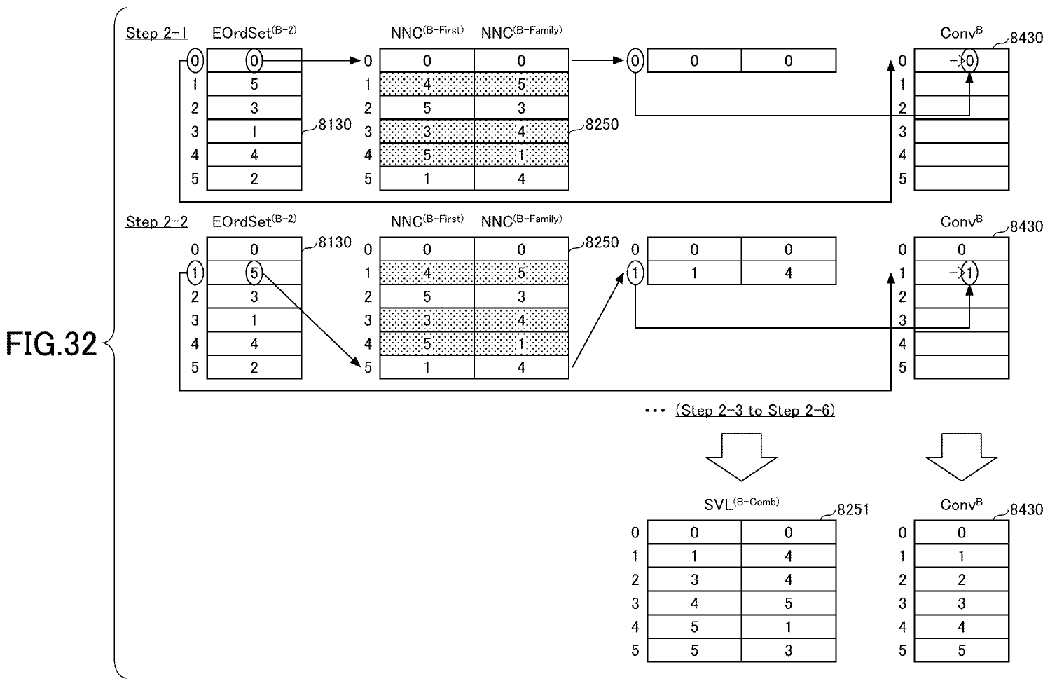

Similarly, the join creating unit 102 creates an SVL 8251 (SVL^{(B-Comb)}) and a Conv 8430 (Conv^{B}) by performing Step 2-1 to Step 2-6 illustrated in FIG. 32. That is, the join creating unit 102 creates the SVL 8251 (SVL^{(B-Comb)}) by outputting the values of the multi-key field 8250 in accordance with the EOrdSet 8130, and sets the output positions of SVL 8251 in the Conv 8430 (Conv^{B}). However, if the value to be output is the same as the previous value, the value is not output.

Step 2-1: The join creating unit 102 uses the value “(0)” stored at the position “0” of the EOrdSet 8130 to output the value “0,0” at the position “0” in the multi-key field 8250 to the position “0” of the SVL 8251. Additionally, the join creating unit 102 stores the output position “0” in the Conv 8430.

Step 2-2: Next, the join creating unit 102 uses the value “5” stored at the position “1” in the EOrdSet 8130 to output the value “(1, 4)” at the position “5” in the multi-key field 8250 to the position “1” of the SVL 8251. Additionally, the join creating unit 102 stores the output position “1” in the Conv 8430.

Thereafter, the SVL 8251 (SVL^{(B-Comb)}) and the Conv 8430 (Conv^{B}) are created by repeating Step 2-3 to Step 2-6 in substantially the same manner.

(3-6) Then, the join creating unit 102 creates a NCC. Specifically, the join creating unit 102 creates an NNC 7510 (NNC^{(A-Comb)}) and an NNC 8510 (NNC^{(B-Comb)}) as follows.

NNC^{(A-Comb)}[i]=Conv^{A}[EOrdSet^{(A-3)}[i]]

NNC^{(B-Comb)}[i]=Conv^{B}[EOrdSet^{(B-3)}[i]]

This indicates that the EOrdSet^{(A-3)} is converted by Conv^{A} to create the NNC^{(A-Comb)}. Similarly, this indicates that EOrdSet^{(B-3)} is converted by Conv^{B} to create the NNC^{(B-Comb)}.

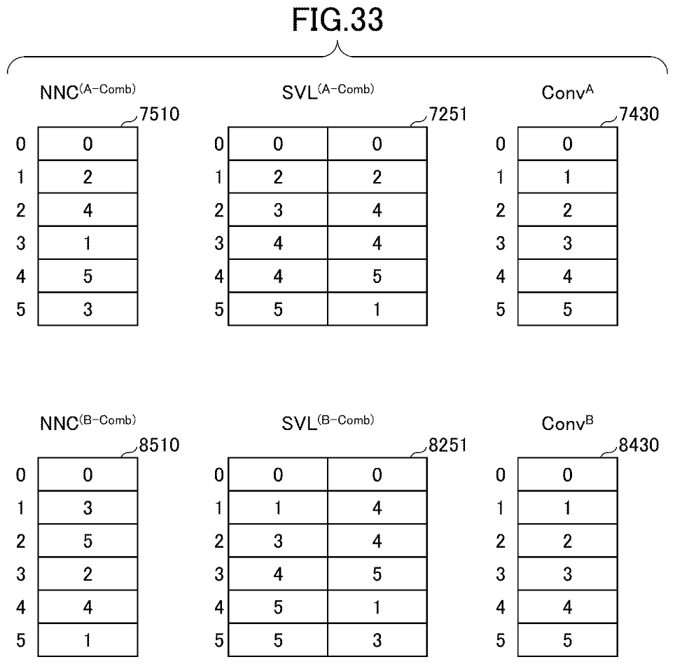

As described above, the NNI format tables illustrated in FIG. 33 are obtained. The NNI format tables illustrated in FIG. 33 are NNI format tables for a join operation that uses multiple columns as keys, and includes the SVL 7251 (SVL^{(A-Comb)}), the Conv 7430 (Conv^{A}) and the NNC 7510 (NNC^{(A-Comb)}) on the master side, and includes the SVL 8251 (SVL^{(B-Comb)}), the Conv 8430 (Conv^{B}) and the NNC 8510 (NNC^{(B-Comb)}) on the slave side.

By creating the NNI format tables illustrated in FIG. 33, the join table in the NNI format can be created by processing substantially the same as that in the case where a single column is used as a join key. Therefore, in the following Step 10-3 to Step 10-5, processing substantially the same as that in the case where a single column is used as a join key is performed.

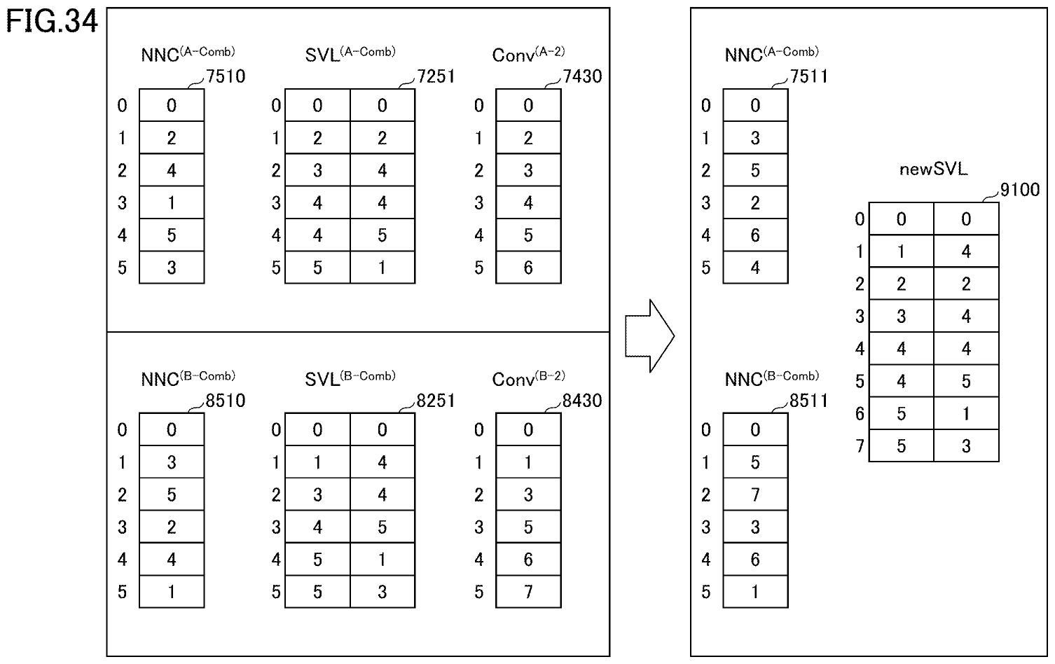

Step 10-3: The join creating unit 102 uses the SVL 7251 (SVL^{(A-Comb)}) and the SVL 8251 (SVL^{(B-Comb)}), and the NNC 7510 (NNC^{(A-Comb)}) and the NNC 8510 (NNC^{(B-Comb)}) to create a common SVL by the above-described common SVL creating process. With this process, as illustrated in FIG. 34, a newSVL 9100, an NNC 7511 (NNC^{(A-Comb)})), and an NNC 8511 (NNC^{(B-Comb)}) are created.

Step 10-4: Next, the join creating unit 102 creates the SAcm. Here, in the case of inner join, SAcm may be created in substantially the same manner as in Step 4-2 described above, and in the case of outer join, the SAcm may be created in substantially the same manner as in Step 6-2 described above.

Step 10-5: Next, the join creating unit 102 creates the MAcm. In the case of inner join, the MAcm may be created in substantially the same manner as in Step 4-3 described above, and in the case of outer join, the MAcm may be created in substantially the same manner as in Step 6-3 described above.

By the above-described Step 10-1 to Step 10-4, a join table using multiple columns as keys is created. Here, the reading a record from the join table is also performed as described in inner join and outer join.

[Searching in the Join Table]

A search in the join table can be achieved by the searching unit 103 performing a search in the master-side table or the slave-side table, and then the join creating unit 102 performing join again. Here, when join is performed again, the common SVL creating process and the processing related thereto have already been completed, and thus it is not necessary to perform them.

Here, there are several types of searches.
A case where a search needs to be performed only in the master side table or the slave side table independently

For example, this is a case of searching in the table 4000 illustrated in FIG. 11 for a record in which a value of the column “Point” is “11” or greater, a case of searching in the table 5000 illustrated in FIG. 11 for a record in which a value of the column “Area” is “North”, and the like. In such a case, join may be performed again after searching in the master side table or the slave side table.
A case where a search is performed in both the master-side table and the slave-side table and “AND” is performed

In this case, join may be performed again after searching in both the master side table and the slave side table.
A case where a search is performed in both the master-side table and the slave-side table and OR is performed

In this case, full outer join may be performed after searching in both the master-side table and the slave-side table.
A case where NOT is performed

In the case of NOT (A AND B), join may be performed again as (NOT A) OR (NOT B).

In the case of NOT (A OR B), join may be performed again as (NOT A) AND (NOT B).

[Sorting the Join Table]

Similar to the search, the sorting of the join table can be achieved by the sorting unit 104 sorting the master-side table or the slave side table, and then the join creating unit 102 performing the join again. However, sorting across both the master-side table and the slave-side table cannot be performed. Here, when join is performed again, the common SVL creating process and the processing related thereto have already been completed, and thus it is not necessary to perform them.

[Aggregating the Join Table]

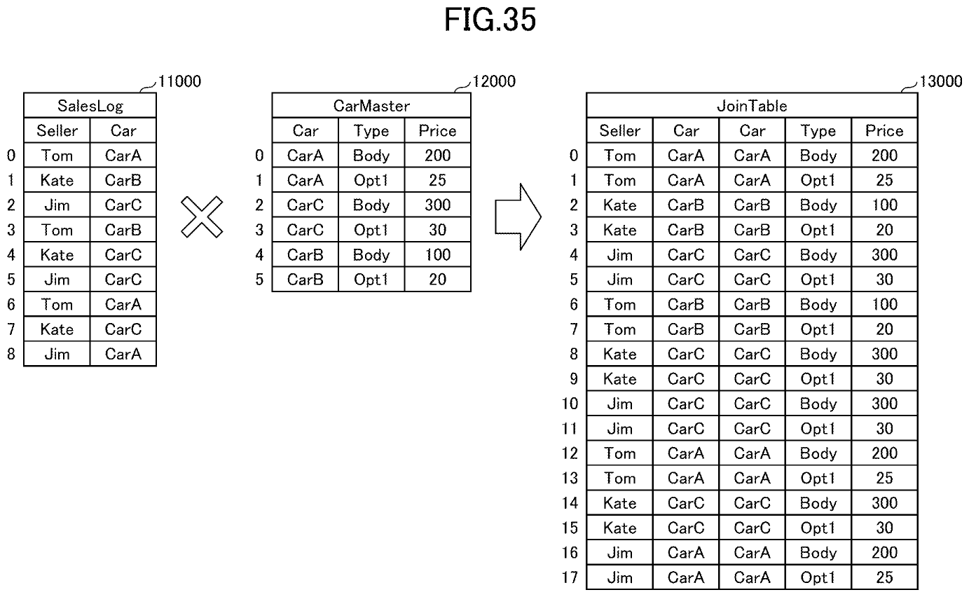

Aggregating the join table will be described. As an example, a join table 13000 illustrated in FIG. 35 is a target of the aggregation operation. The join table 13000 is created by performing join (inner join) on a table 11000 (SalesLog table) and a table 12000 (CarMaster) by using the join key “Car”. Additionally, it is assumed that the dimension of the aggregation is columns “Seller” and “Price”, and the measure is any one of “minimum”, “maximum”, “total”, and “number of items”. Hereinafter, the column “Seller” is also referred to as “Dim 0”, “Price” is also referred to as “Dim 1”, and the measure is also referred to as “Msr”.

At this time, by performing the following Step 11-1 to Step 11-3, the aggregation of a predetermined measure with respect to Dim 0 and Dim 1 is achieved.

Step 11-1: The aggregating unit 105 decomposes the table of the join source by each join key value.

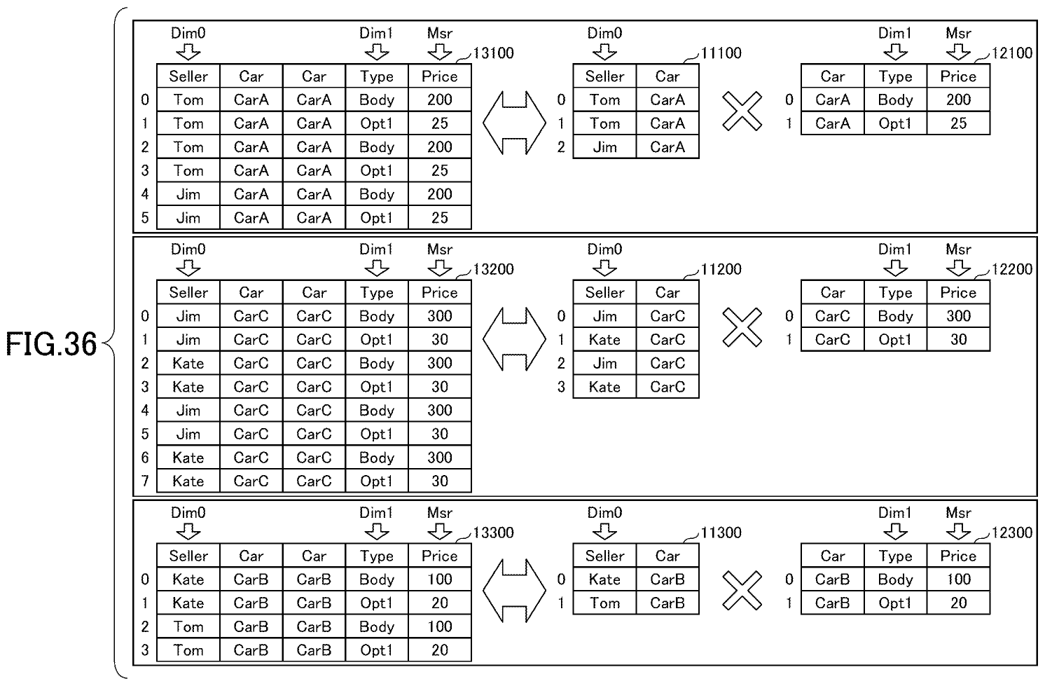

Specifically, as illustrated in FIG. 36, the aggregating unit 105 decomposes the table 11000 (SalesLog table) into a table 11100, a table 11200, and a table 11300 and decomposes the table 12000 (CarMaster) into a table 12100, a table 12200, and a table 12300 for the respective join key values “CarA”, “CarC”, and “CarB”.

Here, the table 11100 is obtained by sorting the table 11000 (SalesLog table) by the join key and extracting only a portion of the join key value “CarA”. Similarly, the table 11200 is obtained by extracting a portion of the join key value “CarC”, and the table 11300 is obtained by extracting only a portion of the join key value “CarB”.

Additionally, the table 12100 is obtained by sorting the table 12000 (CarMaster) by the join key and extracting only a portion of the join key value “CarA”. Similarly, the table 12200 is obtained by extracting only a portion of the join key value “CarC”, and the table 12300 is obtained by extracting only a portion of the join key value “CarB”.

Here, a table 13100 obtained by performing join on the table 11100 and the table 12100 is obtained by extracting joined records by the join key value “CarA” from the join table 13000. Similarly, a table 13200 obtained by performing join on the table 11200 and the table 12200 is obtained by extracting joined records by the join key value “CarC” from the join table 13000. Similarly, a table 13300 obtained by performing join on the table 11300 and the table 12300 is obtained by extracting joined records by the join key value “CarB” from the join table 13000.

Step 11-2: Next, the aggregating unit 105 creates a table in which the number of appearances of the value of the dimension is counted for each join key value, and calculates the product of the tables.

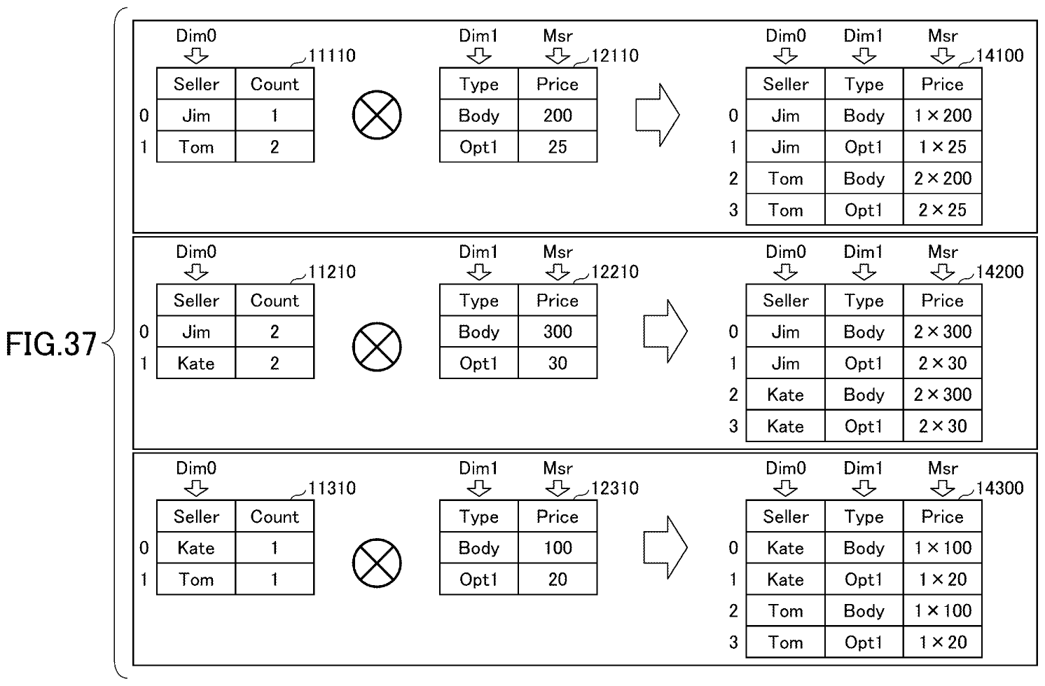

Specifically, as illustrated in FIG. 37, the aggregating unit 105 creates a table 11110 in which the number of appearances of the value of Dim0 is counted with respect to the join key value “CarA” and a table 12110 in which the number of appearances of the value of Dim1 is counted with respect to the join key value “CarA”, and then creates a table 14100 representing the product of the table 11110 and the table 12110.

Similarly, as illustrated in FIG. 37, the aggregating unit 105 creates a table 11210 in which the number of appearances of the value of Dim0 is counted with respect to the join key value “CarC” and a table 12210 in which the number of appearances of the value of Dim1 is counted with respect to the join key value “CarC”, and then creates a table 14200 representing the product of the table 11210 and the table 12210.

Similarly, as illustrated in FIG. 37, the aggregating unit 105 creates a table 11310 in which the number of appearances of the value of Dim0 is counted with respect to the join key value “CarB” and a table 12310 in which the number of appearances of the value of Dim1 is counted with respect to the join key value “CarB”, and then creates a table 14300 representing the product of the table 11310 and the table 12310.

Here, there are a sort method and a cube method as a method for calculating the product of tables. Each calculation method will be described in detail later.

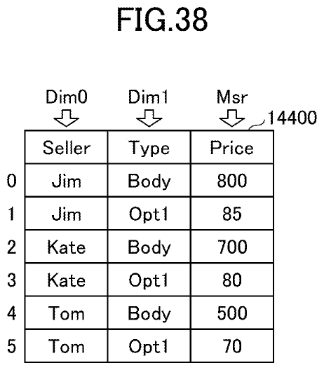

Step 11-3: Then, the aggregating unit 105 calculates the sum of the tables obtained by the product in Step 11-2 described above. The table obtained by this sum is a table representing the aggregation result. Specifically, the aggregating unit 105 calculates the sum of the table 14100, the table 14200, and the table 14300. FIG. 38 illustrates an example of an aggregation result table 14400 when the measure is “total”.

Here, there are a sort method and a cube method as a method for calculating the sum of tables. Each calculation method will be described in detail later.

(Sort Method)

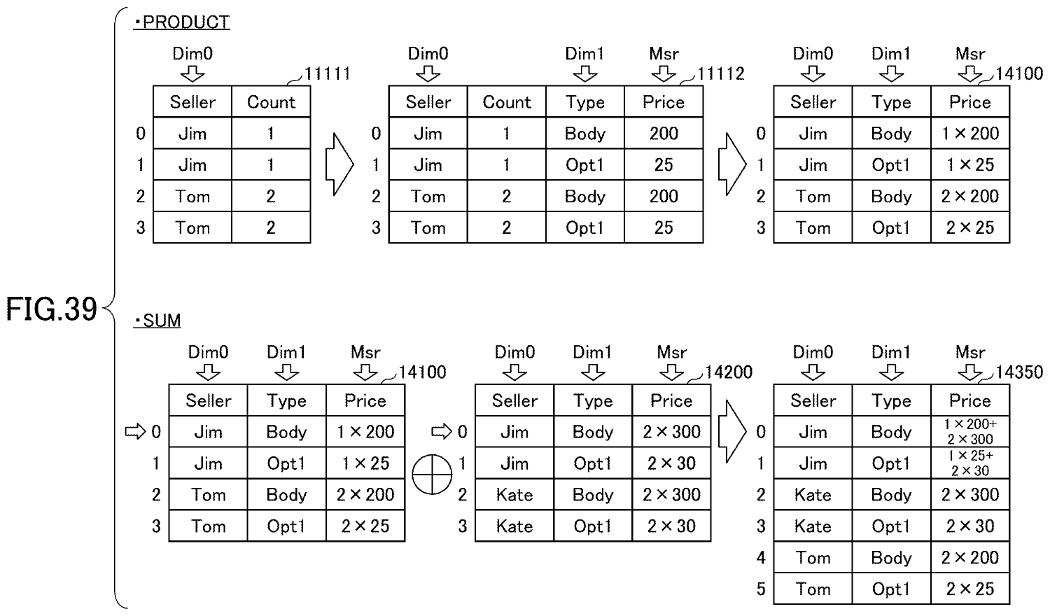

Here, a method of calculating the sum and product of tables by the sort method will be described. As an example, a case of calculating the product of the table 11110 and the table 12110 illustrated in FIG. 37 and a case of calculating the sum of the tables 14100 and 14200 will be described with reference to FIG. 39.

Product

First, the aggregating unit 105 repeats the records in the table 11110, which is the left-side table, by the number of the records in the table 12110, which is the right-side table. That is, because the number of the records in the table 12110 is “2”, each record in the table 11110 is repeated only twice. With this processing, a table 11111 illustrated in FIG. 39 is obtained.

Next, the aggregating unit 105 combines the dimension (Dim0) and the measure (Msr) of the table 12110 on the right side of the values of the dimension (Dim1) of the table 11111. With this processing, a table 11112 illustrated in FIG. 39 is obtained.

Then, when the measure is “total” or “the number of items”, the aggregating unit 105 multiplies the measure by the “Count” value and then deletes the column “Count”. With this processing, the table 14100 (the product operation result table) representing the product of the table 11110 and the table 12110 is obtained.

Here, when the measure is “minimum value” or “maximum value”, the column “Count” is deleted without multiplying the measure by the “Count” value.

Sum

The aggregating unit 105 sets comparison positions at the head of the table 14100 and the head of the table 14200, and then compares the values of the dimensions of the records at the comparison positions to create a sum operation result table representing the sum of the table 14100 and the table 14200.

Specifically, when the values of Dim0 and Dim1 of the records at the comparison positions in the table 14100 and the table 14200 are identical, any one of the following (a) to (c) is performed, and then the comparison positions in both the table 14100 and the table 14200 are lowered by one.

(a) When the Measure is “Total” or “Number of Items”

A record including the values of Dim0 and Dim1 of the record at the comparison position of the table 14100 and the sum of the value of the measure of the record at the comparison position of the table 14100 and the value of the measure of the record at the comparison position of the table 14200 is added to the sum operation result table.

(b) When the Measure is a “Minimum Value”

A record including the values of Dim0 and Dim1 of the record at the comparison position of the table 14100 and a smaller value among the value of the measure of the record at the comparison position in the table 14100 and the value of the measure of the record at the comparison position in the table 14200 is added to the sum operation result table.

(c) When the Measure is a “Maximum Value”

A record including the values of Dim0 and Dim1 of the record at the comparison position in the table 14100 and a larger value among the value of the measure of the record at the comparison position in the table 14100 and the value of the measure of the record at the comparison position in the table 14200 is added to the sum operation result table.

With respect to the above, when the values of Dim0 and Dim1 of the records at the comparison positions in the table 14100 and the table 14200 are not identical, the record having smaller values of Dim0 and Dim1 is added to the sum operation result table, and then the comparison position of the table from which the record is added is lowered by one.

Here, when there is no record to be compared in one table, the remaining record or records in the other table are added to the sum calculation result table, and the processing is ended.

With this processing, the sum operation result table representing the sum of the tables 14100 and 14200 is obtained. Here, a sum operation result table 14350 illustrated in FIG. 39 is a sum operation result table in a case where the measure is “total” or “number of items”.

(Cube Method)

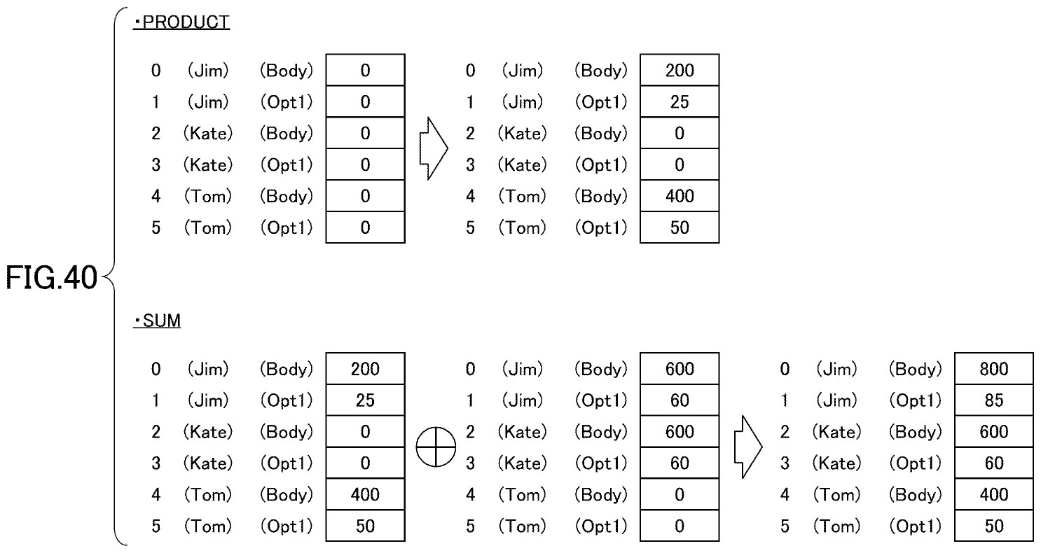

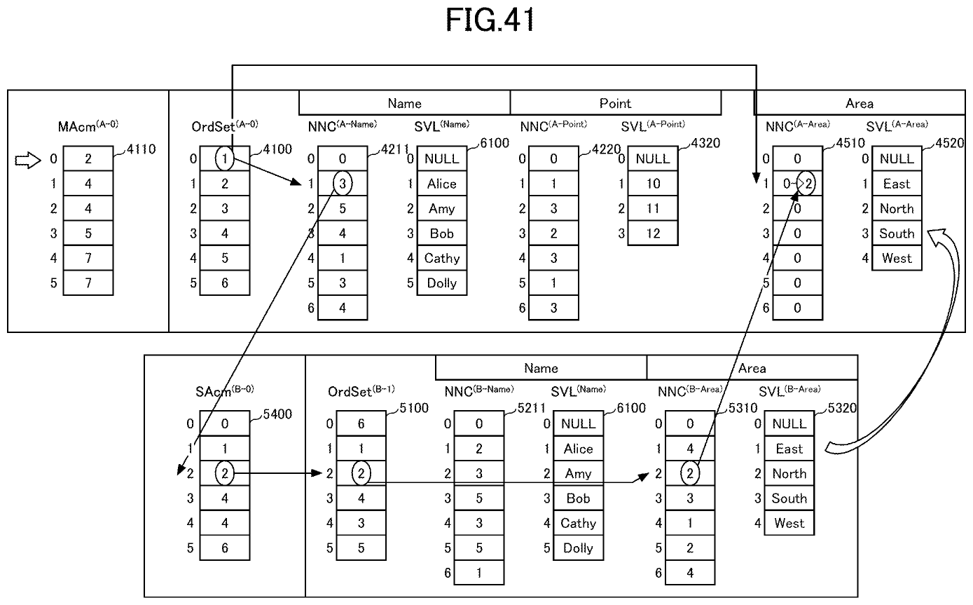

Next, a method of calculating the sum and product of tables by the cube method will be described. As an example, a case where the product of the table 11110 and the table 12110 illustrated in FIG. 37 is calculated and a case where the sum of the table 14100 and the table 14200 is calculated will be described with reference to FIG. 40.

Product

First, the aggregating unit 105 specifies the number of types of values of the dimension to be aggregated. This can be readily identified from the SVL. In the table 11000 and the table 12000, there are three types in Dim0 (i.e., Jim, Kate, and Tom) and two types in Dim1 (i.e., Body and Opt1).

Next, the aggregating unit 105 creates a multidimensional cube having the number of types of the values of the dimension as an axis. Specifically, as illustrated in FIG. 40, a multidimensional cube of 3×2 is created. Here, each cell of the multidimensional cube is filled with “0” when the measure is “total” or “the number of items”, “+∞” when the measure is “the minimum value”, and “−∞” when the measure is “the maximum value”. This is for detecting a case where the value of the measure is not stored in the cell of the multidimensional cube. Additionally, “0” to “5” are addresses of respective cells of the multi-dimensional cube, and represent sets of values of Dim0 and values of Dim1 in ascending order.

Next, the aggregating unit 105 stores the value of the measure in the multidimensional cube. Specifically, for each cell of the multidimensional cube, the value of the measure corresponding to the set of the value of Dim0 and the value of Dim1 indicated by the address (or a value obtained by multiplying the value of the measure by the “Count” value corresponding to the value of Dim0) is stored. Here, when the measure is “total” or “the number of items”, the value obtained by multiplying the value of the measure by the “Count” value is stored, and when the measure is “the minimum value” or “the maximum value”, the value of the measure is stored.

Specifically, because the address “0” represents Jim and Body, “200×1” is stored in the cell of the address “0” when the measure is “total” or “the number of items”, and “200” is stored in the cell of the address “0” when the measure is “the minimum value” or “the maximum value”.

Similarly, because the address “1” represents Jim and Opt1, “25×1” is stored in the cell of the address “1” when the measure is “total” or “the number of items”, and “25” is stored in the cell of the address “1” when the measure is “the minimum” or “the maximum”.

Similarly, because the address “2” represents Kate and Body, “0” is stored in the cell of the address “2” when the measure is “total” or “the number of items”, and “0” is stored in the cell of the address “2” when the measure is “the minimum value” or “the maximum value”.

Similarly, because the address “3” represents Kate and Opt1, “0” is stored in the cell of the address “3” when the measure is “total” or “the number of items”, and “0” is stored when the measure is “the minimum” or “the maximum”.

Similarly, because the address “4” represents Tom and Body, “200×2” is stored in the cell of the address “4” when the measure is “total” or “the number of items”, and “200” in the cell of the address “4” is stored when the measure is “the minimum value” or “the maximum value”.

Similarly, because the address “5” represents Tom and Opt1, “25×2” is stored in the cell of the address “5” when the measure is “total” or “the number of items”, and “25” is stored in the cell of the address “5” when the measure is “the minimum” or “the maximum”.

Then, the aggregating unit 105 deletes a cell in which the value of the measure is not stored from the multidimensional cube. With this processing, a table 14100 (a product operation result table) representing the product of the table 11110 and the table 12110 is obtained.

Sum

The aggregating unit 105 calculates the values of the measure at the same address according to the measure by using the multidimensional cube storing the values of the measure of the table 14100 and the multidimensional cube storing the values of the measure of the table 14200. At this time, when the measure is “total” or “the number of items”, two values of the measure are added, when the measure is “the minimum value”, a smaller value is used, and when the measure is “the maximum value”, a larger value is used.

With this processing, the sum operation result table 14350 representing the sum of the table 14100 and the table 14200 is obtained. Here, the example illustrated in FIG. 40 indicates a case where the measure is “total” or “the number of items”.

(Exchanging Dimensions)

Here, although the product and the sum of the tables are calculated in the above description, the processing becomes complicated if the dimensions to be aggregated are crossed between the left and right tables. Therefore, for example, in a situation where Dim0, Dim2, and Dim4 are present in the left table and Dim1 and Dim3 are present in the right table, the above-described complication can be avoided by exchanging the priorities of the order of the dimensions during the aggregation from Dim0, Dim1, Dim2, Dim3, and Dim4 to Dim0, Dim2, Dim4, Dim1, and Dim3 while the aggregation is being performed. In this case, after the aggregation is performed, the aggregation result table may be sorted by priorities of Dim0, Dim1, Dim2, Dim3, and Dim4.

[Column Transfer]

The column transfer for the join table is an operation of copying a column of the slave-side table to the master-side table via the join key. The SVL of the column to be transferred may be copied as is, and the speed is high because it is completed by recalculating the NNC.

Because join can be also performed on subtables (for example, a table obtained by performing a certain search on a certain table), the column transfer can also be performed on subtables on the master side and the slave side.

As an example, a case where the column transfer is performed on the join table illustrated in FIG. 15 and the “Area” column on the slave side is copied to the master side will be described.

First, as illustrated in FIG. 41, the column transferring unit 106 copies the SVL 5320 (SVL^{(B-Area)}) to the master side to create an SVL 4520 (SVL^{(A-Area)}).

Next, the column transferring unit 106 creates an NNC 4510 (NNC^{(A-Area)}) and fills its elements with 0. The elements of the NNC 4510 (NNC^{(A-Area)}) are updated (recalculated) to complete the column transfer.

As illustrated in FIG. 41, the column transferring unit 106 determines whether the following conditions 1 and 2 are satisfied for i=1, . . . , 6.
Condition 1: MAcm^{(A-0)}[i]>MAcm^{(A-0)}[i−1]
Condition 2: SAcm [NNC^{(A-Name)}[OrdSet^{(A-0)}[i]]]>SAcm[NNC^{(A-Name)}[OrdSet^{(A-0)}[i]]−1]
   When the above-described conditions 1 and 2 are satisfied, the column transferring unit 106 updates the elements of the NNC 4510 (NNC^{(A-Area)}) as follows.

NNC^{(A-Area)}[OrdSet^{(A-0)}[i]]NNC^{(B-Area)}[OrdSet^{(B-1)}[SAcm[−1+NNC^{(A-Name)}[OrdSet^{(A-0)}[i]]]]]

The example illustrated in FIG. 41 indicates that the value of NNC^{(A-Area)}[1] is updated from 0 to 2.

Here, by selecting OrdSet^{(A-x)} (where x is an integer greater than or equal to 1) instead of OrdSet^{(A-0)}, the column transfer can be similarly performed for a subtable.

[Extracting the Matched Set in Join and the Unmatched Set in Join]

In the join table, a set of records matched in join and a set of records unmatched in join can be easily extracted. The extracted set is registered as a new OrdSet in the master-side table or the slave-side table. Such a set can be used for various purposes, and, for example, can be used to implement fast correlation subqueries. Hereinafter, for simplicity, a set of records matched in join is also referred to as a “matched set”, and a set of records unmatched in join is also referred to as an “unmatched set”.

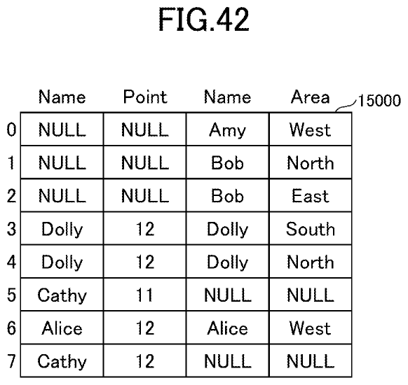

As an example, a case where a matched set and an unmatched set are extracted from a join table 15000 illustrated in FIG. 42 will be described. The join table 15000 illustrated in FIG. 42 is a table obtained by combining a subtable, obtained by searching for records that satisfies “Point≥11” in the table 4000, and the table 5000 by outer join.

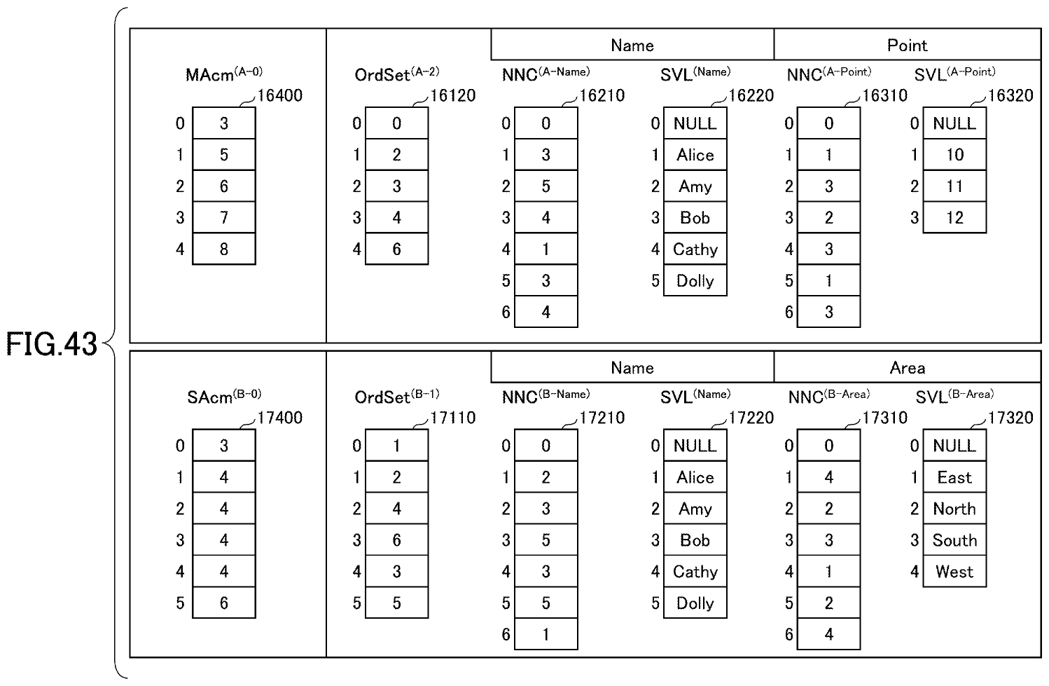

FIG. 43 illustrates the join table 15000 illustrated in FIG. 42 in the NNI format. As illustrated in FIG. 43, the NNI format of the join table 15000 illustrated in FIG. 42 includes a MAcm 16400 (MAcm^{(A-0)}), an OrdSet 16120 (OrdSet^{(A-2)}), an NNC 16210 (NNC^{(A-Name)}), an SVL 16220 (SVL^{(Name)}), an NNC 16310 (NNC^{(A-Point)}), an SVL 16320 (SVL^{(A-Point)}), an SAcm 17400 (SAcm^{(B-0)}), an OrdSet 17110 (OrdSet^{(B-1)}), an NNC 17210 (NNC^{(B-Name)}), an SVL 17220 (SVL^{(Name)}), an NNC 17310 (NNC^{(B-Area)}), and an SVL 17320 (SVL^{(B-Area)}). Here, the SVL 16220 (SVL^{(Name)}) and the SVL 17220 (SVL^{(Name)}) are common SVLs.

(When Viewed from the Master Side)

Here, when viewed from the master-side table, each record of the join table 15000 is divided into the following cases with respect to how the record is created.

Case-0: A case where the master side is not involved in join (for example, the records at positions “0” to “2” in the join table 15000)

Case-1: Matched case (for example, the records at positions “3” to “4” and “6” in the join table 15000)

Case-2: Unmatched case (for example, the records at positions “5” and “7” in join table 15000) Therefore, a matched set when viewed from the master side is a set of records corresponding to Case-1 described above, and an unmatched set is a set of records corresponding to Case-2 described above.

Specifically, the set extracting unit 107 can extract the matched set and the unmatched set by performing the following Step 12-1 to Step 12-2 for i=0, 1, . . . , 4.

Step 12-1: First, the set extracting unit 107 determines whether MAcm^{(A-0)}[i]−MAcm^{(A-0)}[i−1]>0. Here, Step 12-2 is not performed when MAcm^{(A0)}[i]−MAcm^{(A-0)}[i−1]=0.

Step 12-2: If it is determined that MAcm^{(A-0)}[i]−MAcm^{(A-0)}[i−1]>0, the set extracting unit 107 determines the value of OrdSet^{(A-2)}[i] according to the following, and adds (or does not add) the value of the matched set or the unmatched set according to the determination result.

If OrdSet^{(A-2)}[i]=0

In this case, because the record on the master side is NULL, the case corresponds to Case-0. Therefore, the value is not added to the matched set or the unmatched set.

If OrdSet^{(A-2)}[i]≠0

In this case, Count (Master [i])=SAcm^{(A-0)}[NNC^{(A-Name)}[OrdSet^{(A-2)}[i]] ]−SAcm^{(A-0)}[NNC^{(A-Name)}[OrdSet^{(A-2)}[i]]−1] is further calculated, and it is determined whether Count(Master[i])>0. Then, if Count(Master[i])>0, the case corresponds to Case-1, and thus the value of OrdSet^{(A-2)}[i] is added to the matched set. If Count(Master[i])=0, the case corresponds to Case-2, and thus the value of OrdSet^{(A-2)}[i] is added to the unmatched set.

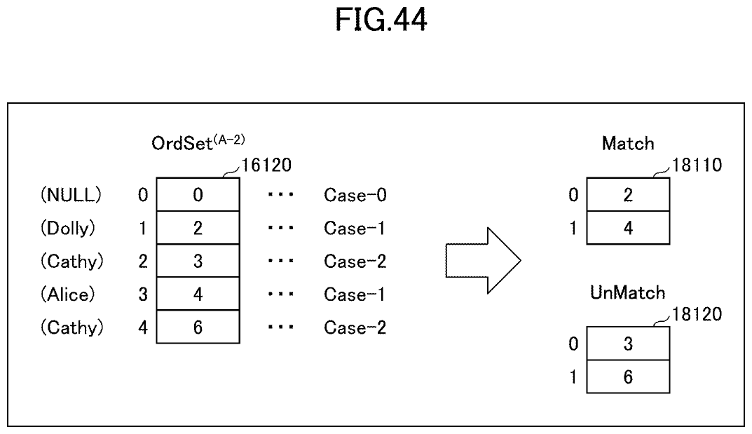

With this processing, as illustrated in FIG. 44, a matched set 18110 and an unmatched set 18120 are created from the elements of the OrdSet 16120 (OrdSet^{(A-2)}).

(When Viewed from the Slave Side)

Next, a case when viewed from the slave-side table will be described. In this case, Case-0 when viewed from the master side corresponds to Case-2, and Case-2 when viewed from the master side corresponds to Case-0.

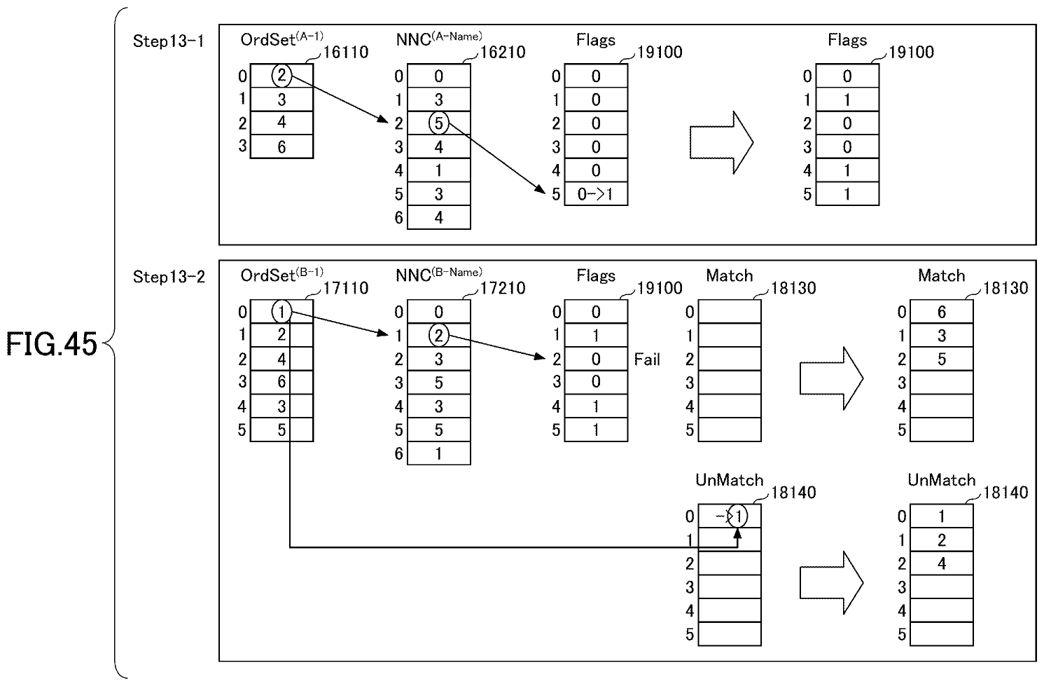

Specifically, as illustrated in FIG. 45, the set extracting unit 107 can extract the matched set and the unmatched set by performing the following Step 13-1 to Step 13-2.

Step 13-1: First, the set extracting unit 107 creates a flag array 19100 by using an OrdSet 16110 (OrdSet^{(A-1)}) and the NNC 16210 (NNC^{(A-Name)}). Here, the OrdSet 16110 (OrdSet^{(A-1)}) is the OrdSet of the master-side table before the creation of the join table 15000 (or an OrdSet obtained by removing the leading 0 from the OrdSet 16120 (OrdSet^{(A-2)}).

The set extracting unit 107 sets the value of each element of the flag array 19100 (Flags) for i=0, 1, . . . , 5 as follows.

Flags[NNC^{(A-Name)}[OrdSet^{(A-1)}[i]]]:=1

Step 13-2: Next, the set extracting unit 107 adds each element of the OrdSet 17110 (OrdSet^{(B-1)}) to the matched set or the unmatched set by using the OrdSet 17110 (OrdSet^{(B-1)}), the NNC 17210 (NNC^{(B-Name)}), and the flag array 19100 (Flags).

For i=0, 1, . . . , 5, the set extracting unit 107 adds the value of the OrdSet^{(B-1)}[i] to the matched set or the unmatched set as follows.

It is determined whether Flags[NNC^{(B-Name)}[OrdSet^{(B-1)}[i]] ]=1, and if Flags [NNC^{(B-Name)}[OrdSet^{(B-1)}[i]] ] is 1, the value of the OrdSet^{(B-1)}[i] is added to the matched set, and if Flags [NNC^{(B-Name)}[OrdSet^{(B-1)}[i]] ] is 0, the value of the OrdSet^{(B-1)}[i] is added to the unmatched set. With this processing, a matched set 18130 and an unmatched set 18140 are created from the respective elements of the OrdSet 17110 (OrdSet^{(B-1)}). Here, when viewed from the slave side, the element of the flag array is not referred to for the record corresponding to Case-0.

The present invention is not limited to the specifically disclosed embodiments described above, and various modifications, changes, combinations with known techniques, and the like can be made without departing from the scope of the claims.

What is claimed is:

1. An information processing method to be performed by a computer, the information processing method comprising:
performing aggregation in a plurality of dimensions included in a virtual table for each value of a predetermined key, two tables in a natural number index format being combined by join using the predetermined key in the virtual table; and
calculating a sum of results of the aggregation.

2. The information processing method as claimed in claim 1, wherein the performing of the aggregation includes decomposing the two tables into a first subtable and a second subtable respectively, for each value of the predetermined key, and calculating a product of the first subtable and the second subtable.

3. The information processing method as claimed in claim 2, wherein the performing of the aggregation includes counting a number of appearances of each value in a dimension among the plurality of dimensions included in the first subtable, adding a value obtained by the counting of the number of the appearances to the first subtable, and calculates the product of the first subtable and the second subtable.

4. The information processing method as claimed in claim 2, wherein the product and the sum are calculated by a sort method or a cube method.

5. The information processing method as claimed in claim 2,
wherein a measure of the aggregation is a minimum, a maximum, a total, or a number of items, and
wherein the performing of the aggregation includes calculating the product of the first subtable and the second subtable in accordance with the measure of the aggregation.

6. The information processing method as claimed in claim 5, wherein the calculating of the sum includes calculating the sum of the results of the aggregation in accordance with the measure of the aggregation.

7. The information processing method as claimed in claim 1,
wherein priorities of the aggregation are assigned to the plurality of dimensions,
wherein the two tables are a master-side table and a slave-side table,
wherein the information processing method further comprising exchanging priorities such that a priority of a dimension included in the slave-side table is lower than a priority of a dimension included in the master-side table, in a case where the priority of the dimension included in the slave-side table is higher than the priority of the dimension included in the master-side table, and
wherein the exchanging of the priorities includes restoring the exchanged priorities to original priorities after the sum is calculated.

8. An information processing device comprising:
a processor; and
a memory storing program instructions that cause the processor to:
perform aggregation in a plurality of dimensions included in a virtual table for each value of a predetermined key, two tables in a natural number index format being combined by join using the predetermined key in the virtual table; and
calculate a sum of results of the aggregation.

9. A non-transitory computer-readable recording medium having stored therein a program causing a computer to perform a method comprising:
performing aggregation in a plurality of dimensions included in a virtual table for each value of a predetermined key, two tables in a natural number index format being combined by join using the predetermined key in the virtual table; and
calculating a sum of results of the aggregation.
